(19) United States
(12) Patent Application Publication
(10) Pub. No.: US 2014/0223338 A1
(43) Pub. Date: Aug. 7, 2014

(54) SYSTEMS AND METHODS FOR A PILOT AND PERSONAL RELATIONSHIP MANAGER

(71) Applicants: Mary Okocha, Sunnyvale, CA (US); Thomas Hill, Sunnyvale, CA (US); Matt Parzych, Sunnyvale, CA (US)

(72) Inventors: Mary Okocha, Sunnyvale, CA (US); Thomas Hill, Sunnyvale, CA (US); Matt Parzych, Sunnyvale, CA (US)

(21) Appl. No.: 14/160,407

(22) Filed: Jan. 21, 2014

Related U.S. Application Data
(60) Provisional application No. 61/754,491, filed on Jan. 18, 2013.
(60) Provisional application No. 61/754,492, filed on Jan. 18, 2013.
(60) Provisional application No. 61/754,493, filed on Jan. 18, 2013.

(51) Int. Cl. G06F 3/0484; G06Q 10/10

(52) U.S. Cl. CPC G06F 3/0484; G06Q 10/107
USPC 715/762

(57) ABSTRACT

A system comprising of a pilot module, and other modules configured to generate a personal process consisting of milestones, goals and timelines based on a preconfigured process or input from a user of a type of event related to the process or user decisions, and link emails and other communications, contacts, events, and resources with the milestones, goals and timing within the generated process, and display messages and events in a manner prioritized based on the process and links therewith; and a plurality of other modules configured to work in conjunction with the pilot module to allow the a user to manage the generated process.

### CROSS-REFERENCE TO RELATED APPLICATIONS

This application claims the benefit of U.S. provisional application 61/754,491 filed Jan. 18, 2013; U.S. provisional application 61/754,492 filed Jan. 18, 2013; and U.S. provisional application 61/754,493 filed Jan. 18, 2013; all of which are hereby incorporated by reference.

### BACKGROUND

1. Technical Field

The embodiments described herein are related to managing work, communications and personal relationships, and in particular managing work, communications and personal relationships in the context of and in relationship to personal, goal oriented processes.

2. Related Art

Much research and development has been put into customer relationship management (CRM) tools of organizations and corporations to help them manage their contacts in an effective way so as to help them achieve certain goals, namely increased sales.

In general, CRM is a widely implemented model for managing a company's interactions with customers, clients, and sales prospects. It involves using technology to organize, automate, and synchronize business processes—principally sales activities, but also those for marketing, customer service, and technical support. The overall goals are to find, attract, and win new clients, service and retain those the company already has, entice former clients to return, and reduce the costs of marketing and client service. Customer relationship management describes a company-wide business strategy including customer-interface departments as well as other departments. Measuring and valuing customer relationships is critical to implementing this strategy.

In the course of an individual's life, however, they are often faced with important, even life changing events that they must deal with, overcome, recover from, etc. These events and the manner in dealing with them represent critical personal processes that require the individual to leverage their personal relationships, personal skills, digital assets activities, efforts, etc., in order to achieve their personal goals related to these critical life changing events.

Unfortunately, there does not currently exist a tool that individuals can use to manage these important personal processes in order to deal with or overcome such events.

### SUMMARY

The embodiments disclosed herein relate to a platform that includes a pilot and a personal relationship manager that allows an individual to either use predefined processes or custom-define a process for managing a life transition or event, establish milestones, goals, and timelines related to such a process, link emails, contacts, events, and reminders to the milestones and goals, and link-in resources to help them achieve the milestones and goals. In addition, the platform allows the individual or user to manage goals, tasks, communications and digital assets/work.

These and other features, aspects, and embodiments are described below in the section entitled “Detailed Description.”

### BRIEF DESCRIPTION OF THE DRAWINGS

Features, aspects, and embodiments are described in conjunction with the attached drawings.

FIGS. 1-35 are example screenshots that illustrate various example views and features of a tool in accordance with various embodiments.

FIG. 36 is a diagram illustrating an example processing system that can be configured to implement the system described herein.

### DETAILED DESCRIPTION

The example embodiments described below relate to a tool that can be used by individuals to manage important, personal processes. Non-limiting examples of these processes can include a job hunt, retirement planning, wedding planning, family management, health management, a divorce, the death of a loved one, general life-goals, etc. When one is faced with such events, it can be very difficult to find the motivation to deal with them. Obviously, the loss of a job, the loss of a loved one and divorce can create feelings and emotions that make one want to run and hide, as opposed to deal with these events in a positive and constructive manner. But the lasting effect of not doing so can be even worse than the effects of the event itself. But even if one were motivated to deal with such events in as positive and constructive a manner as possible, one often doesn't know how to do so, where to find help, what resources to rely on, etc. This can lead to an even greater sense of despair or anxiety that makes one want to not deal with such situations.

The tool described herein is intended to help individuals (e.g., users) deal with these events and the like by helping them define and follow a process to deal with it that includes meaningful milestones and goals. For example, a user can then link emails, events, reminders, contacts and resources to these different goals and milestones and use the tool to achieve goals and milestones. Once the process is defined within the tool, dashboards and other automated processes can be used to help guide and incentivize the user to complete the process and thereby, hopefully deal successfully with the event or issue.

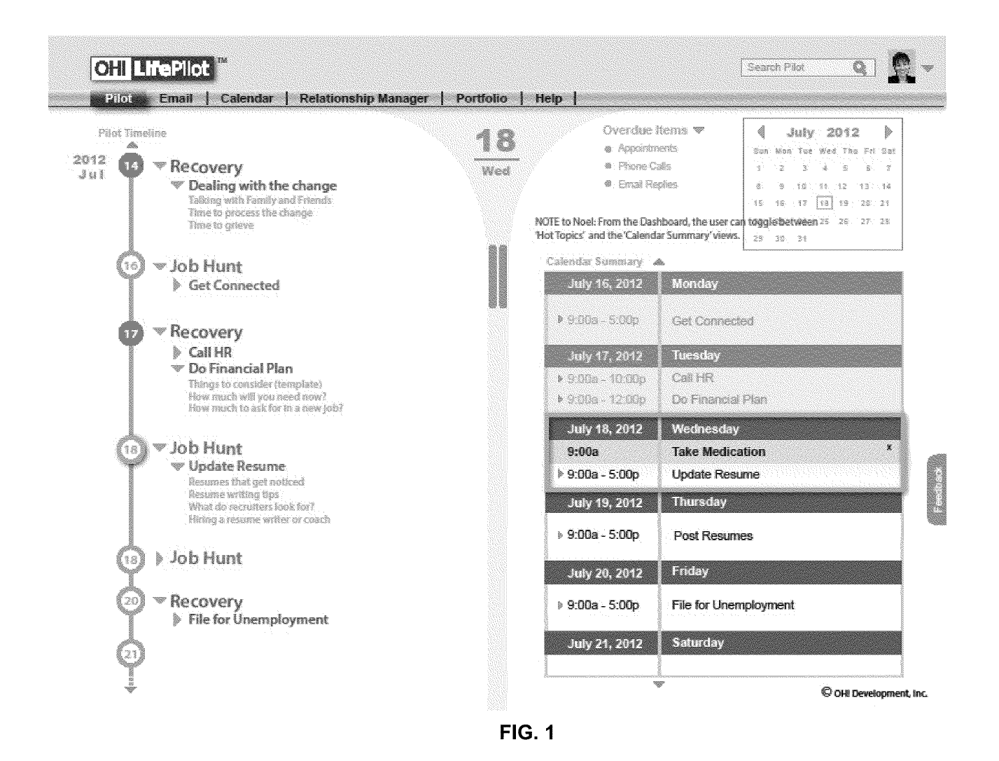

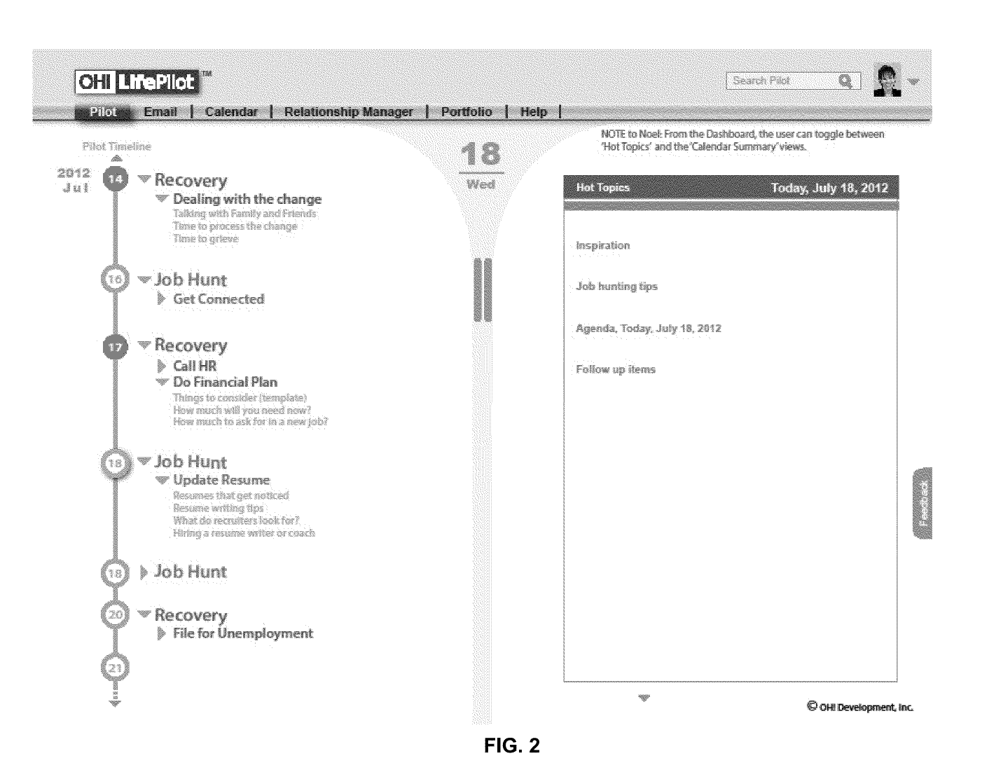

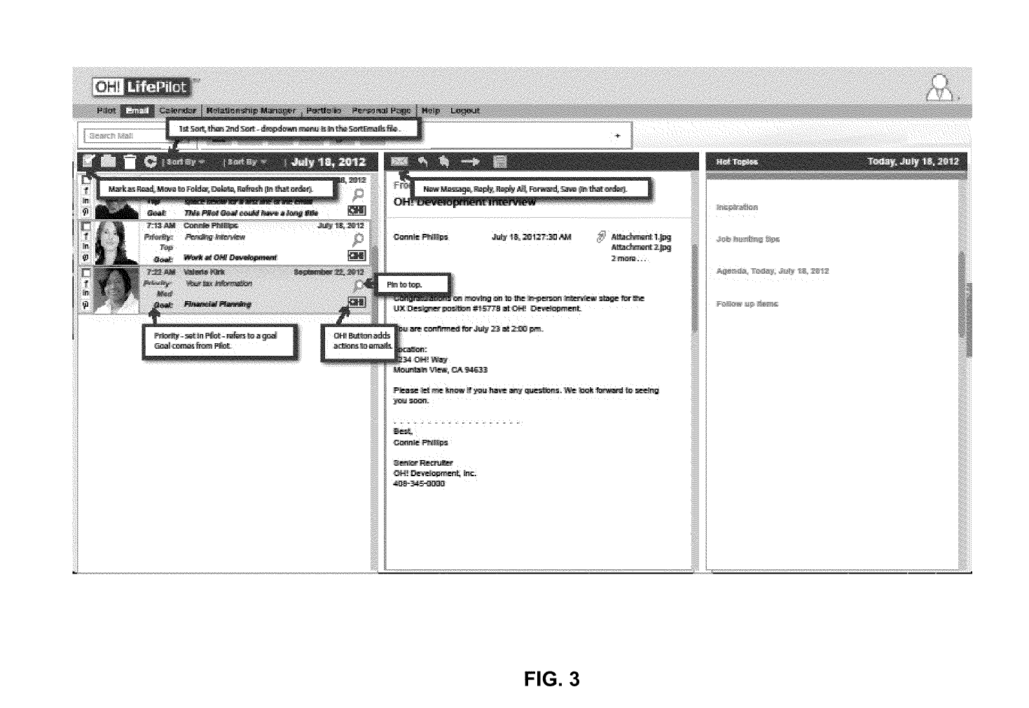

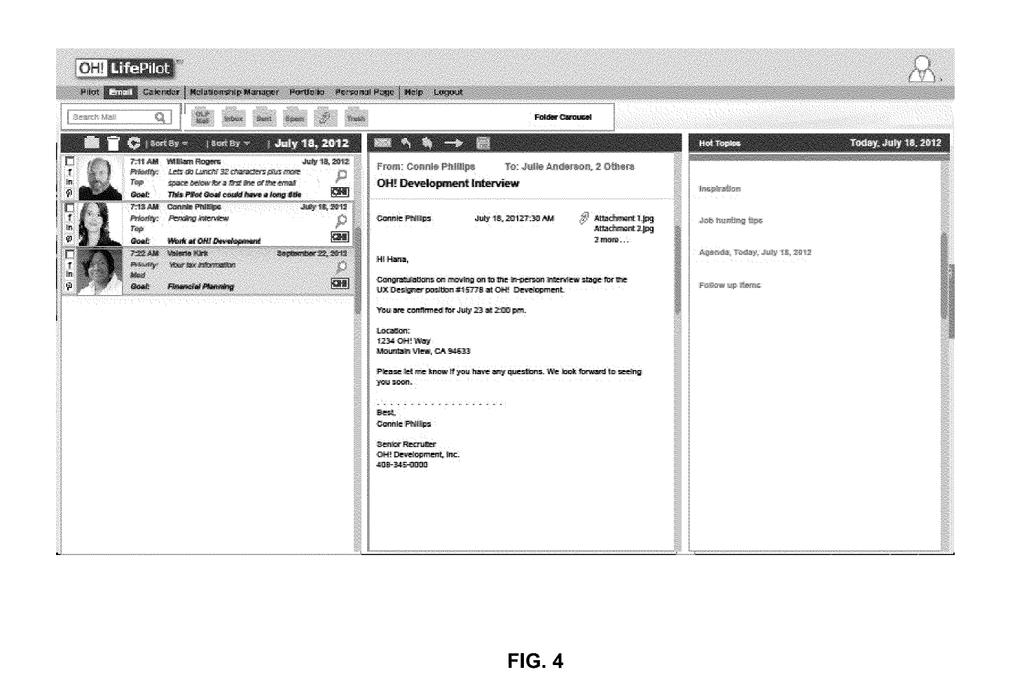

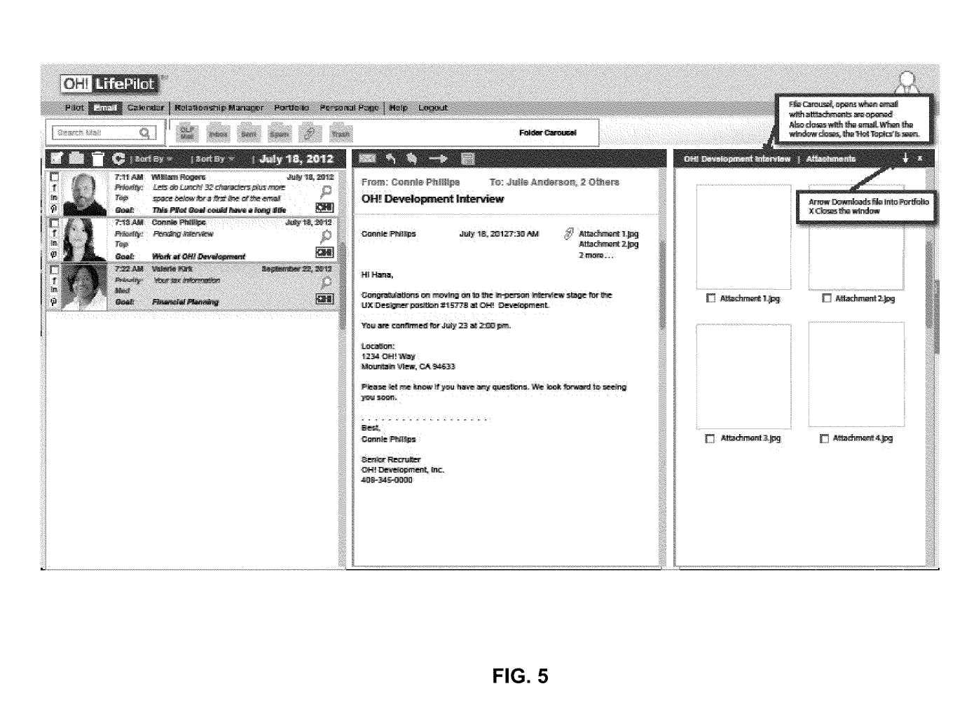

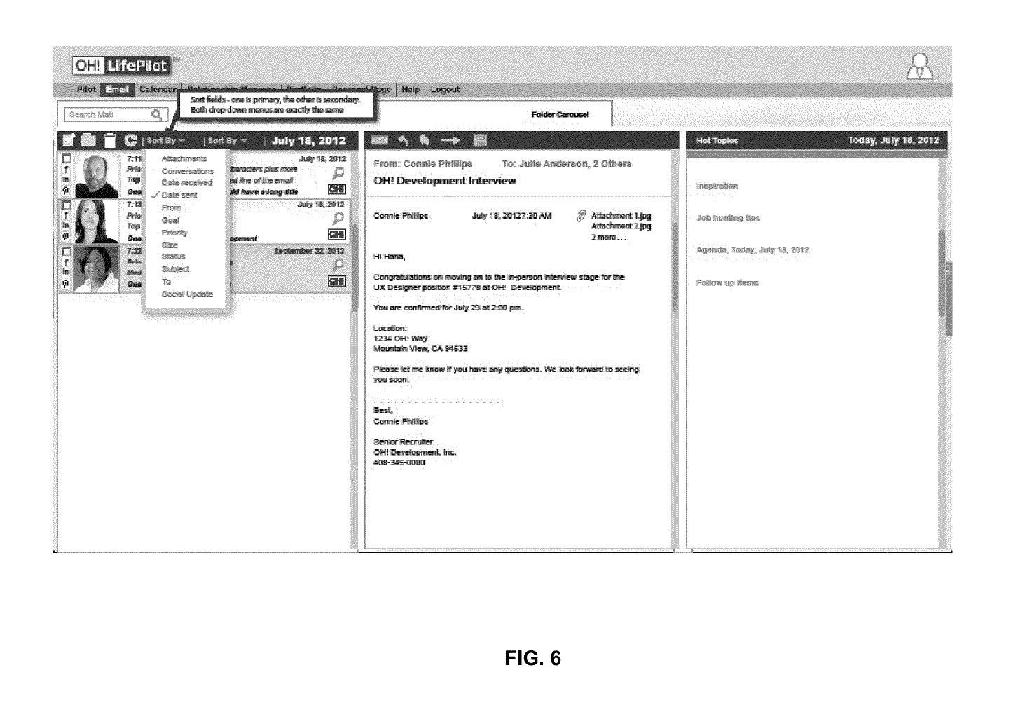

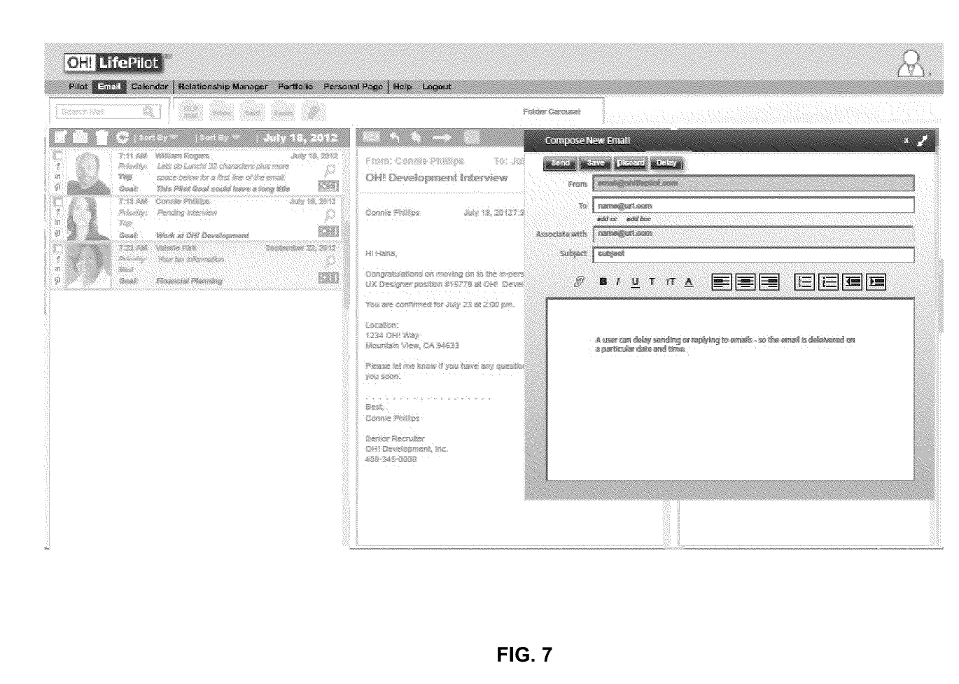

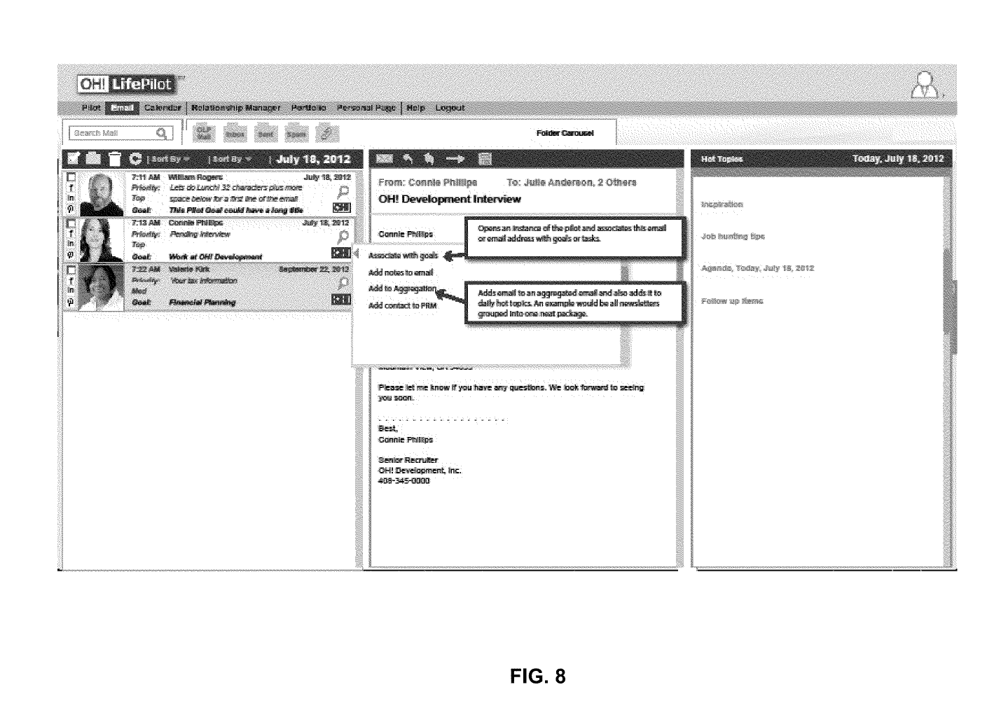

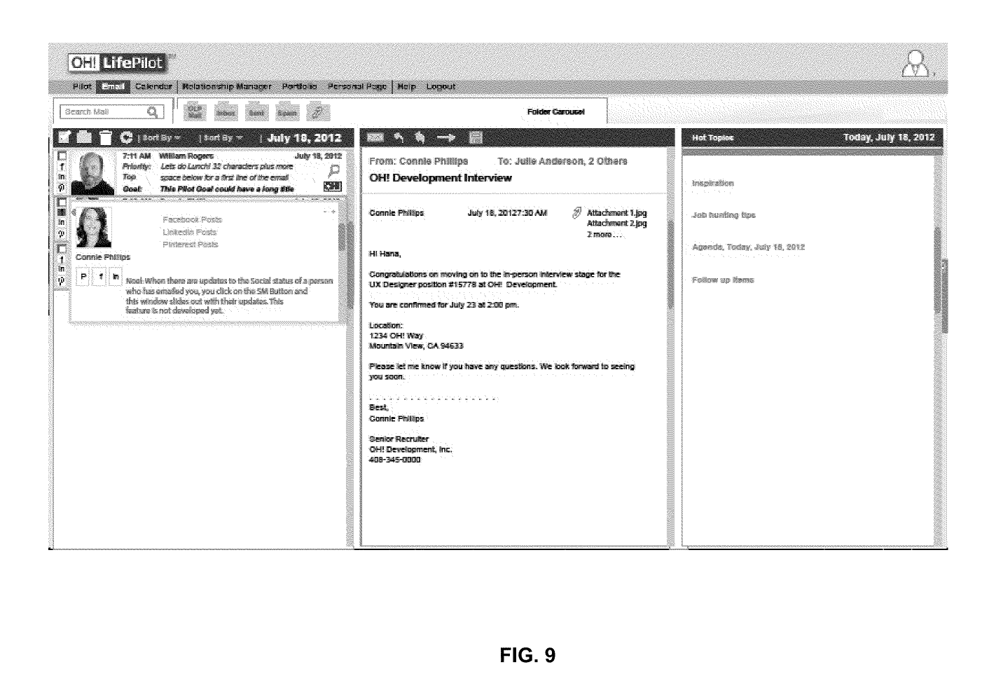

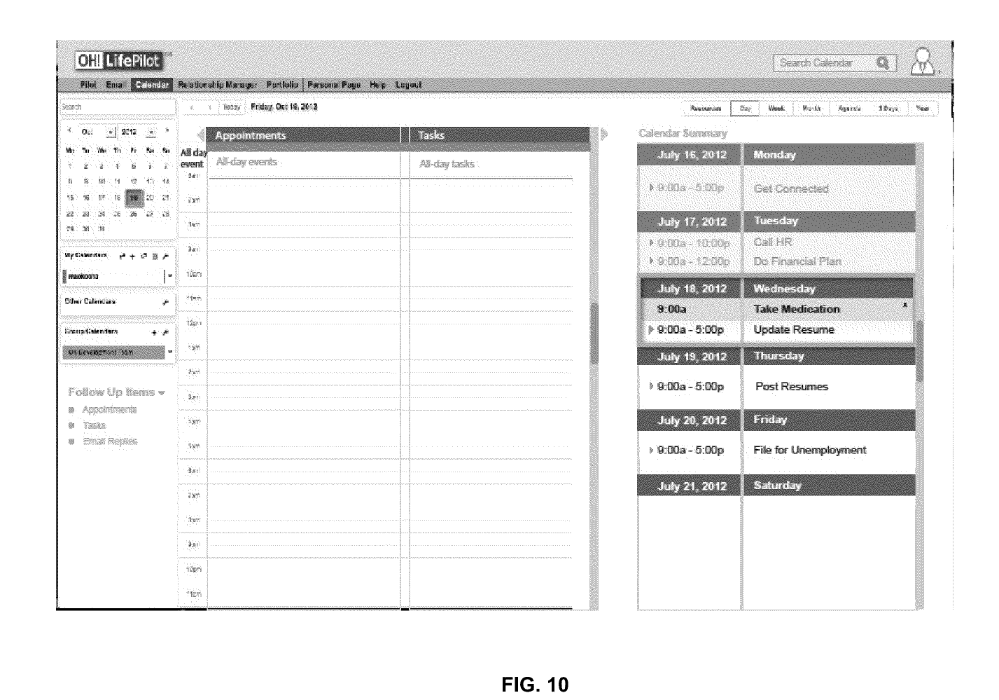

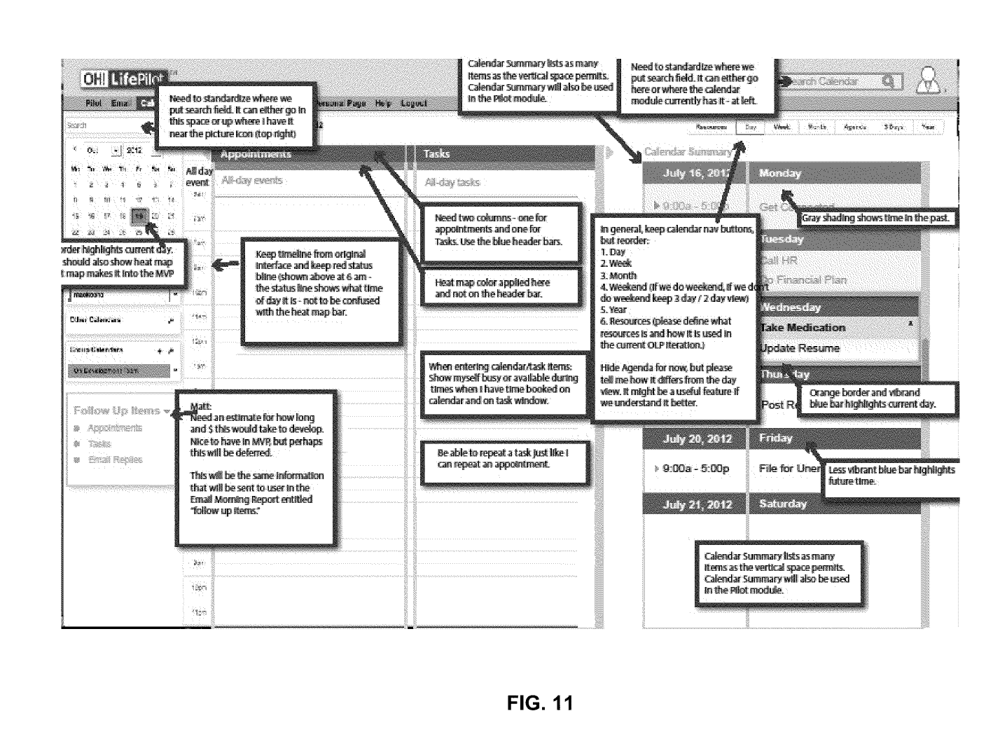

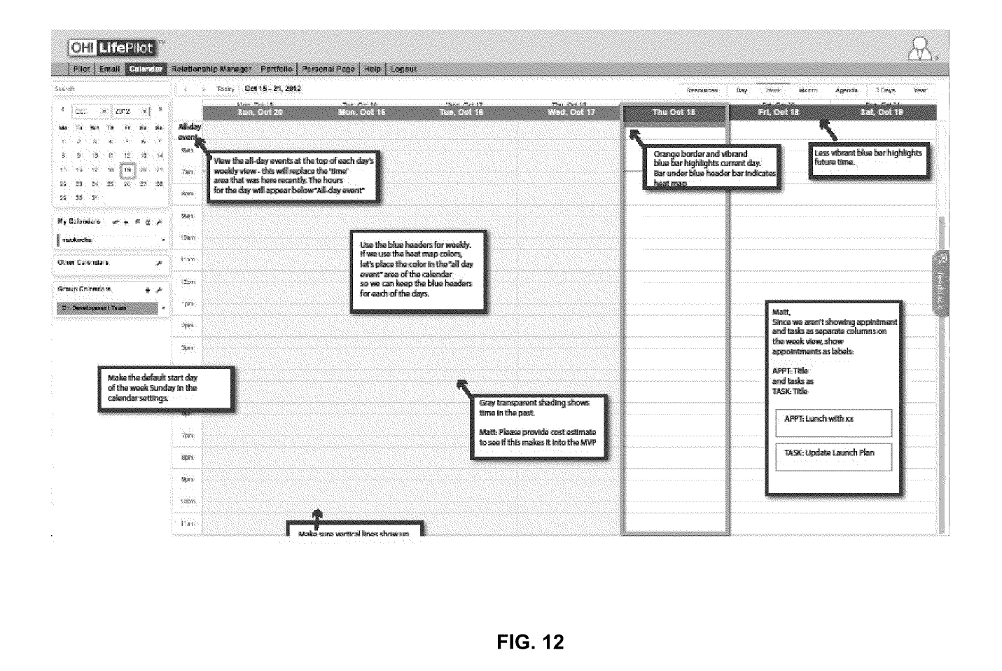

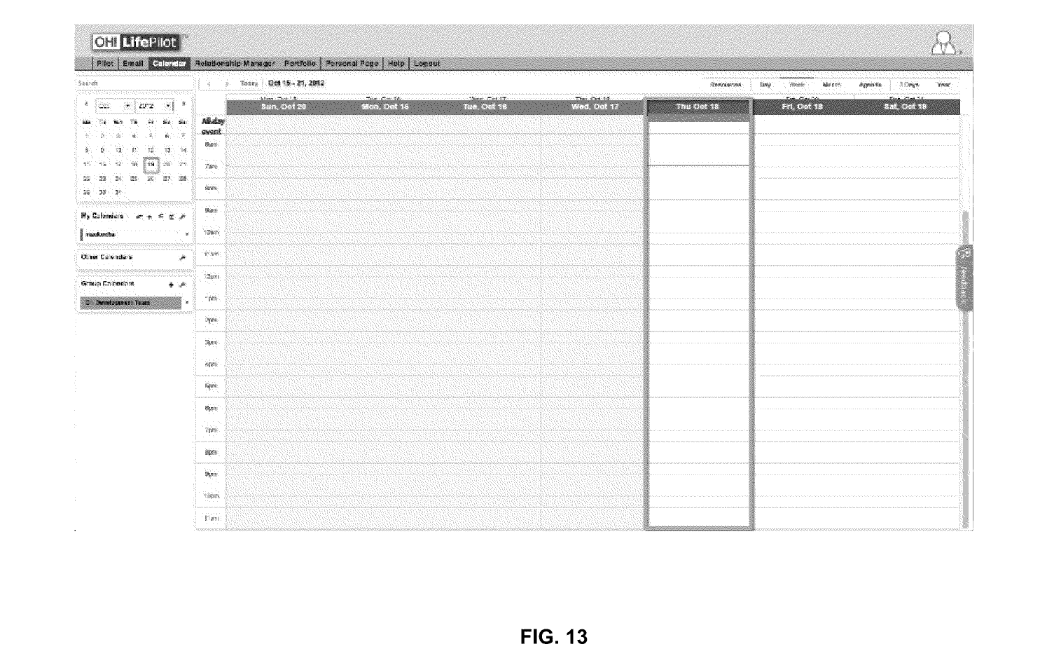

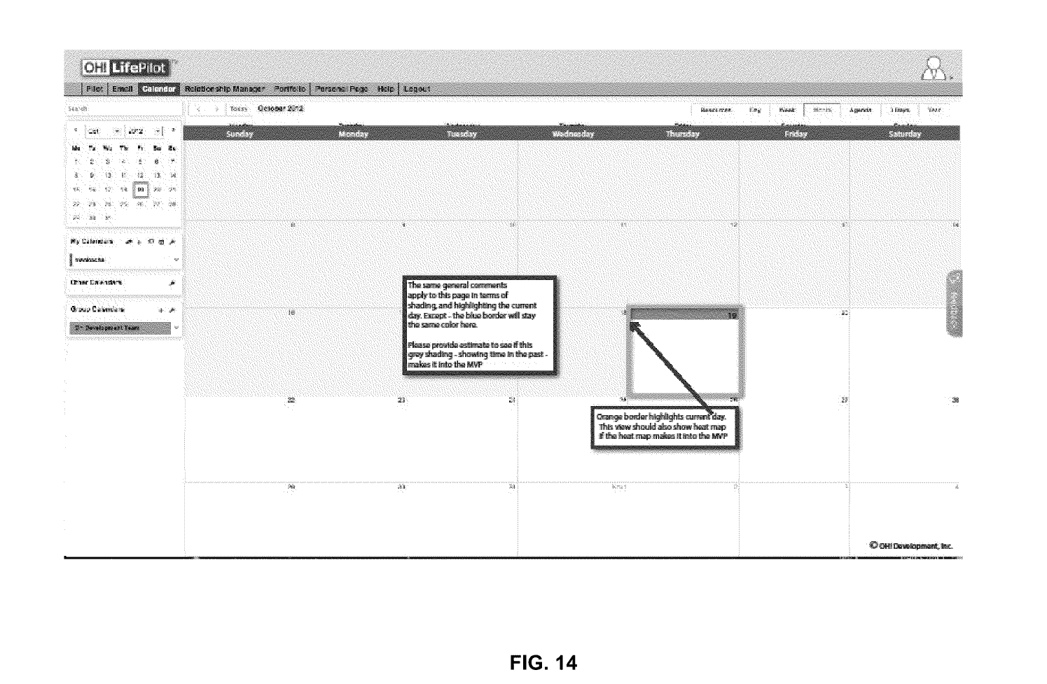

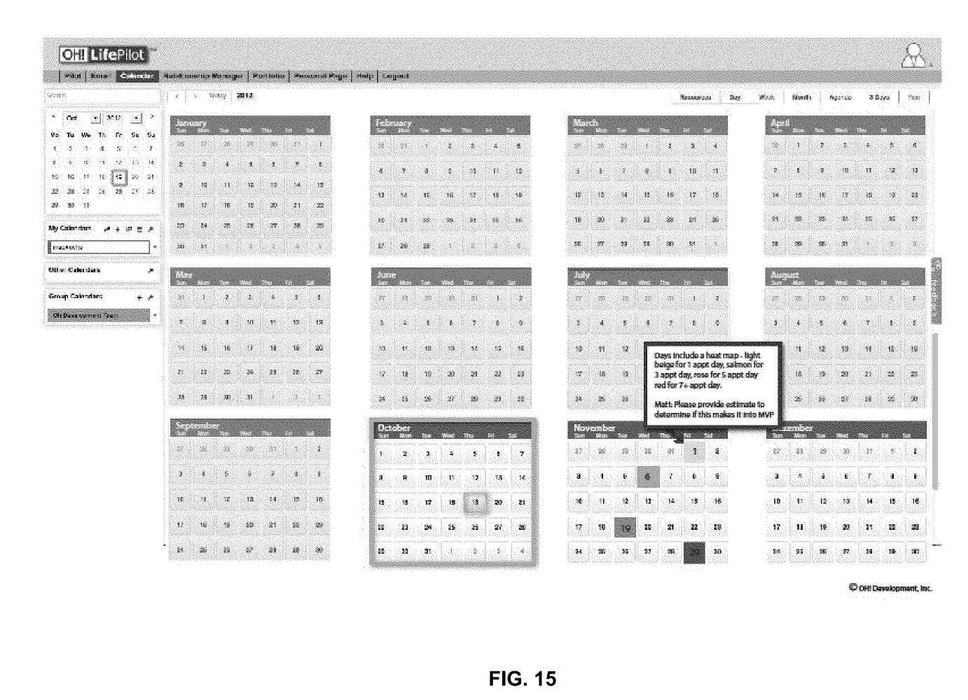

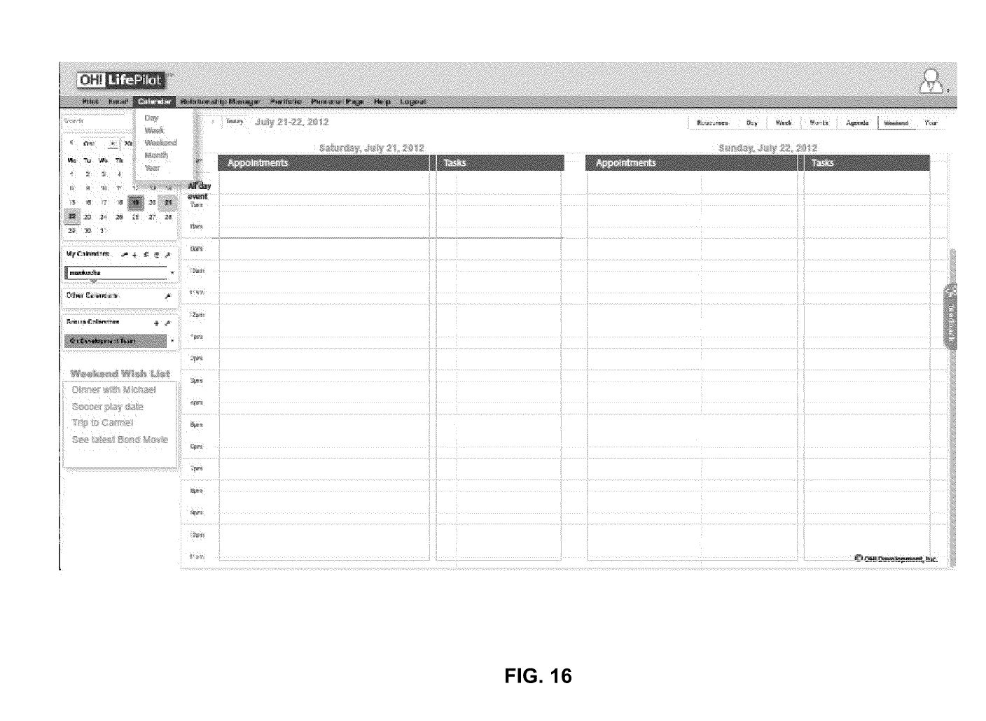

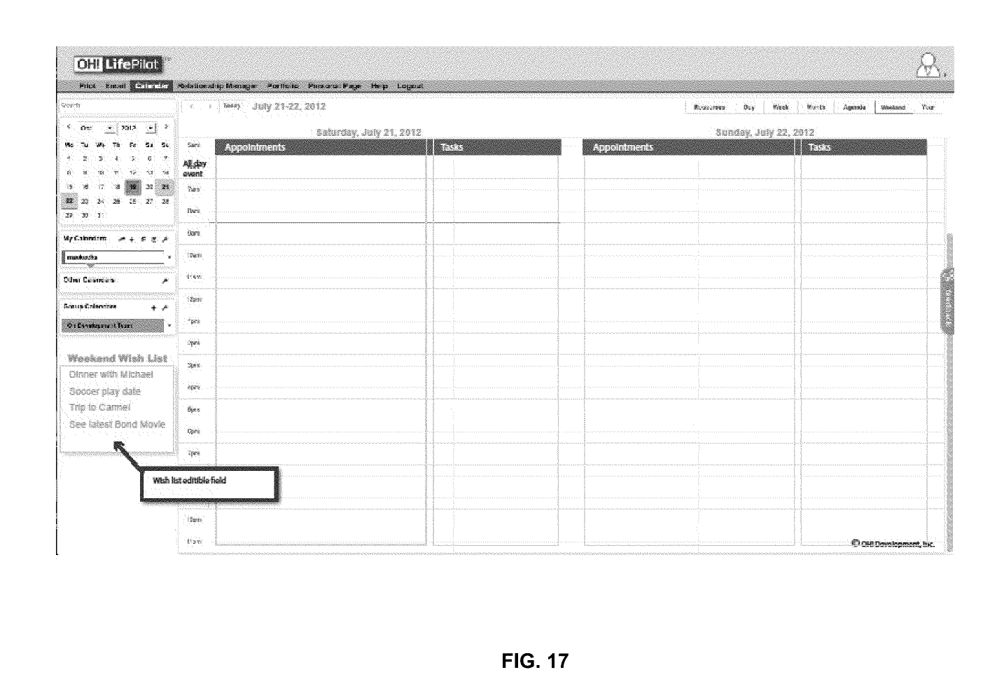

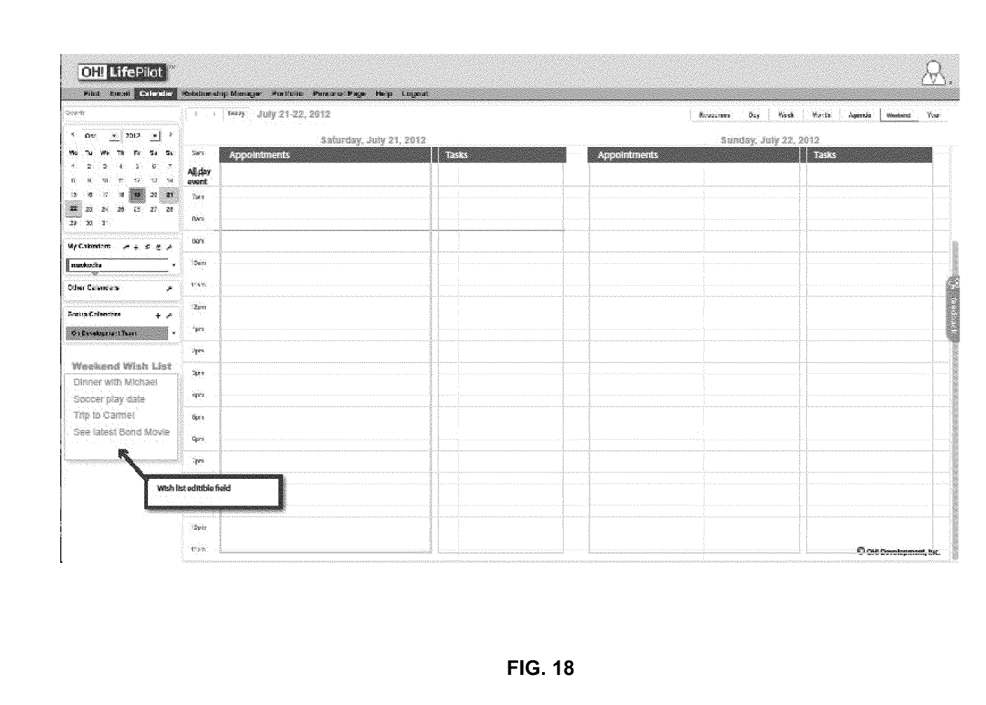

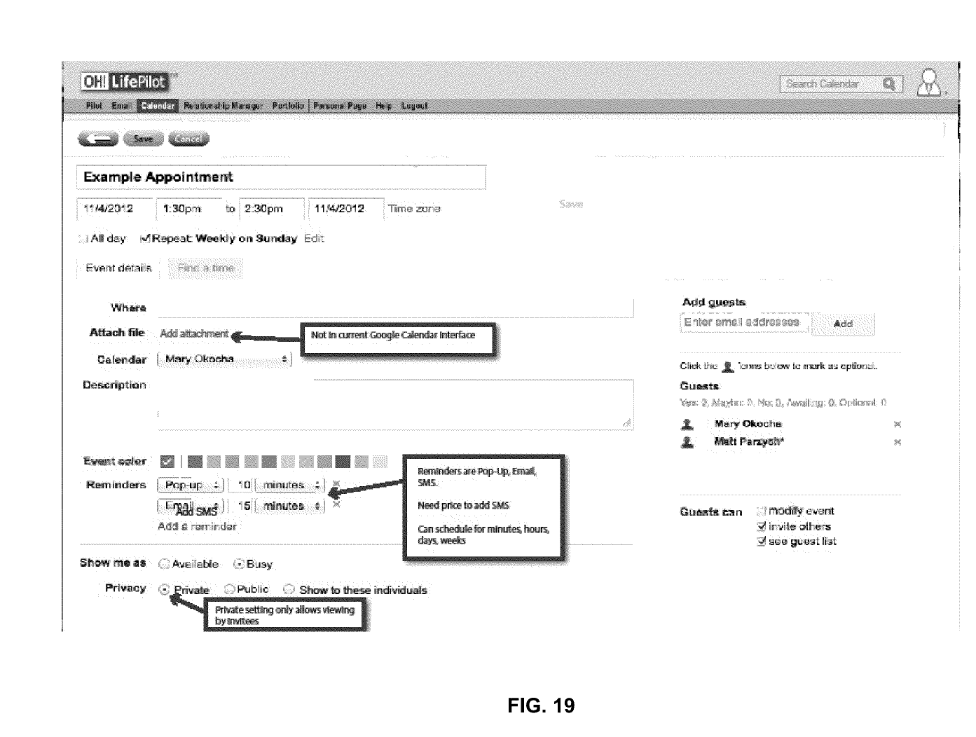

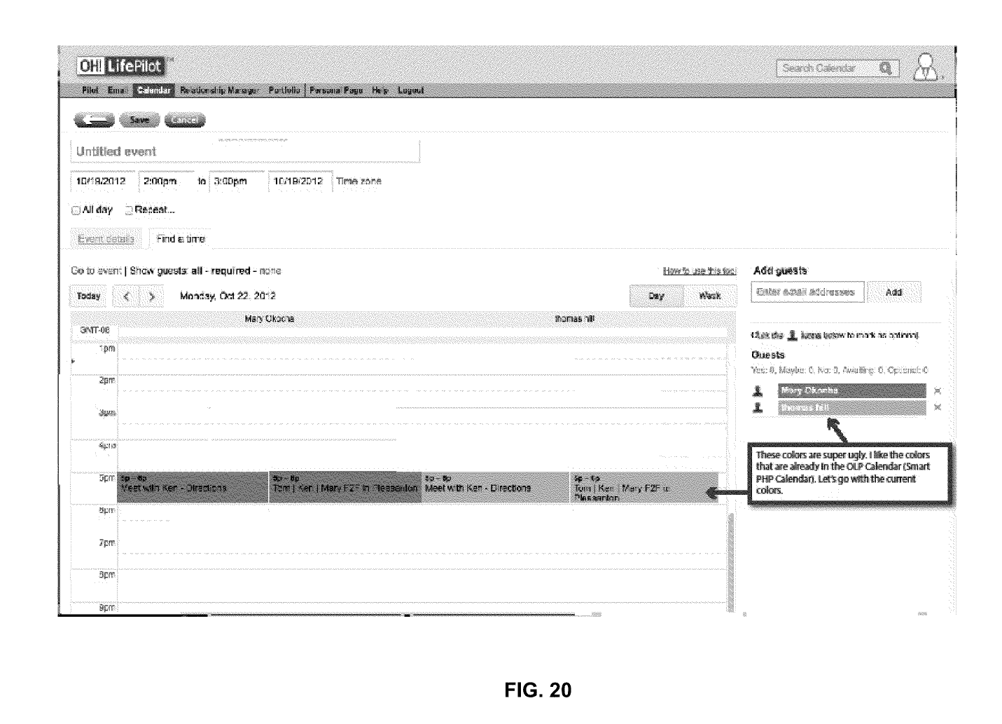

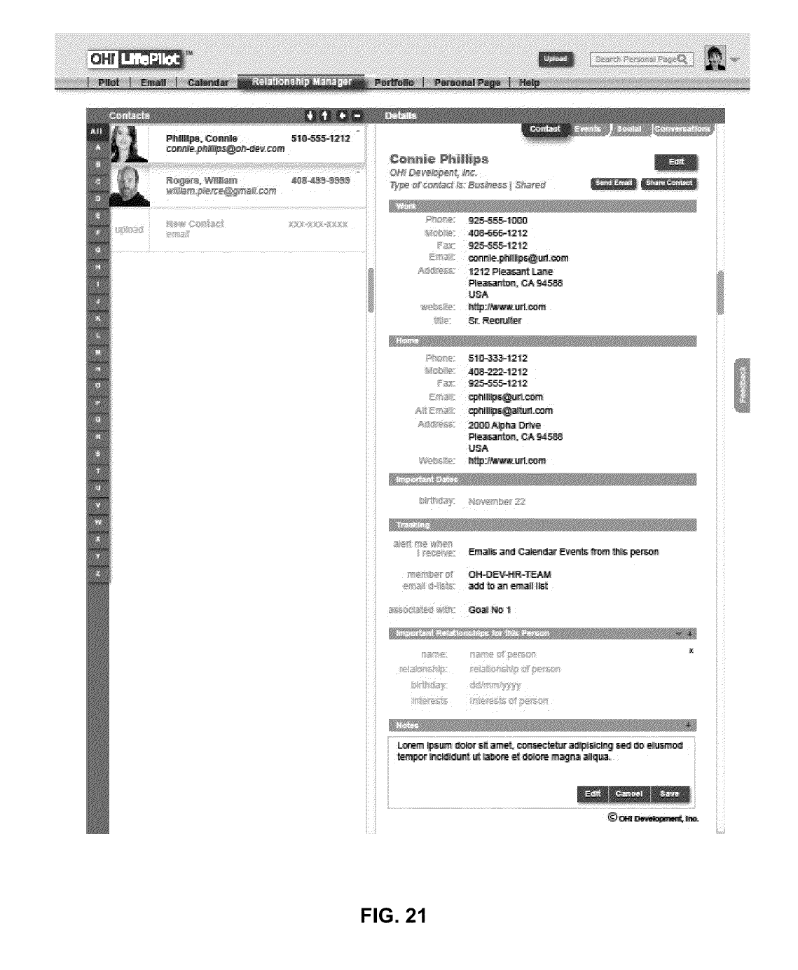

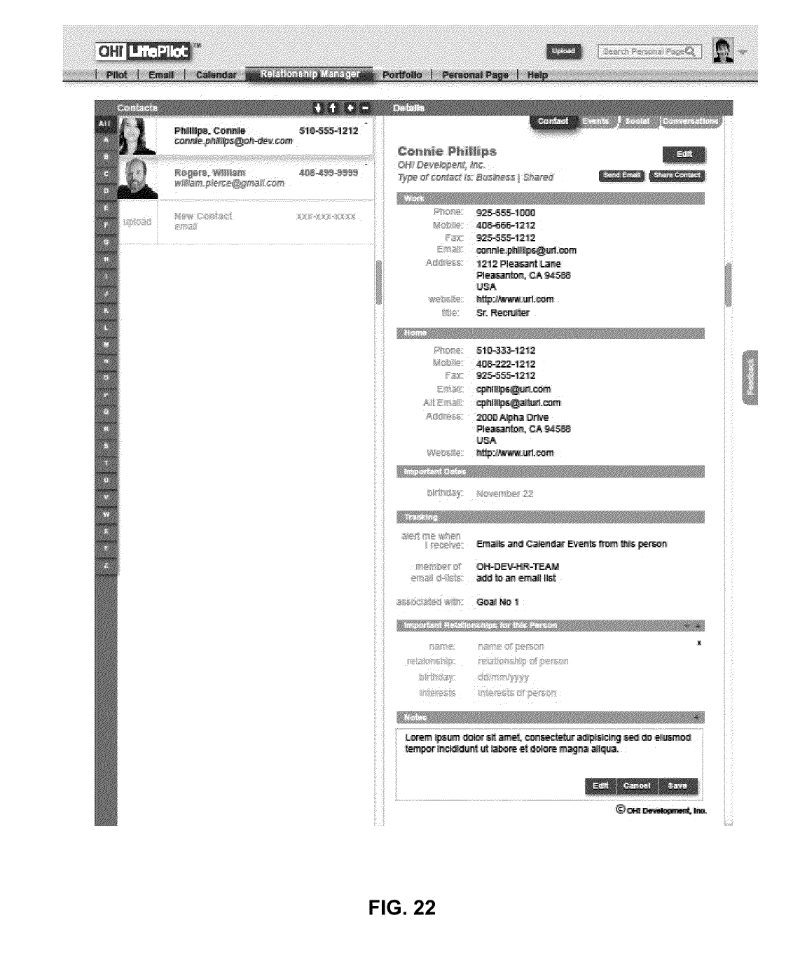

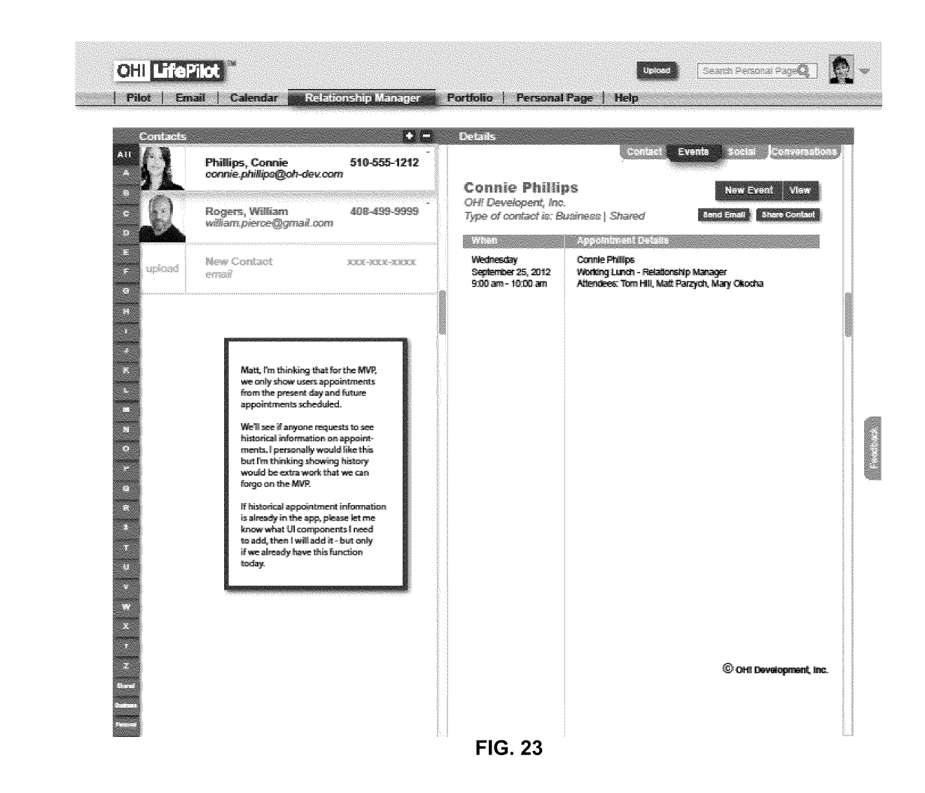

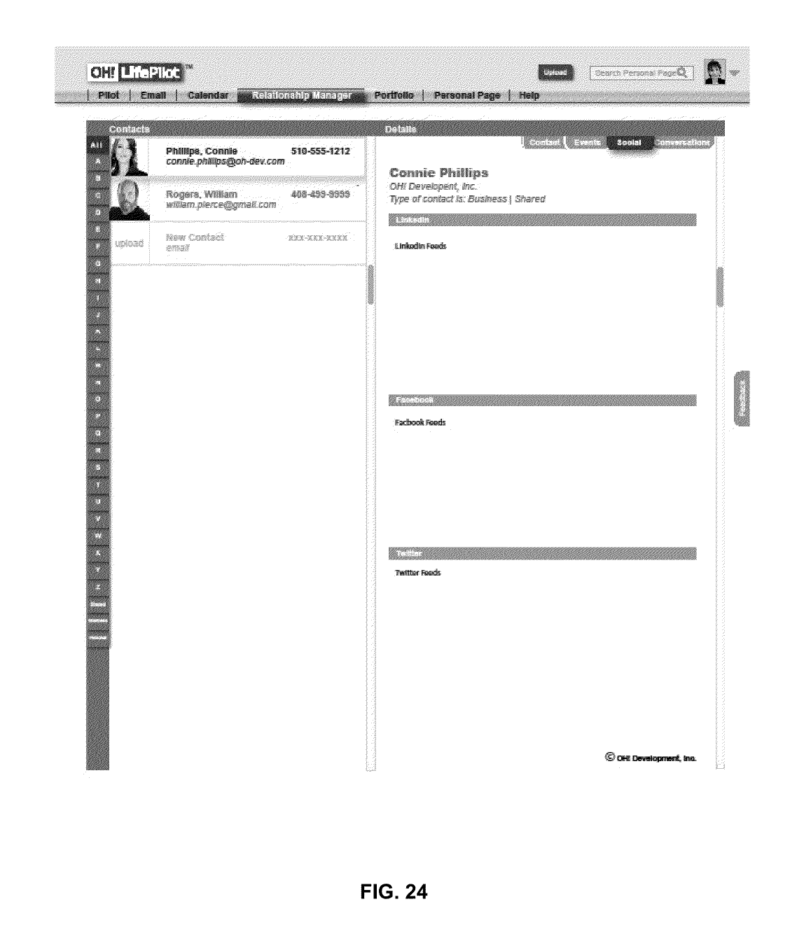

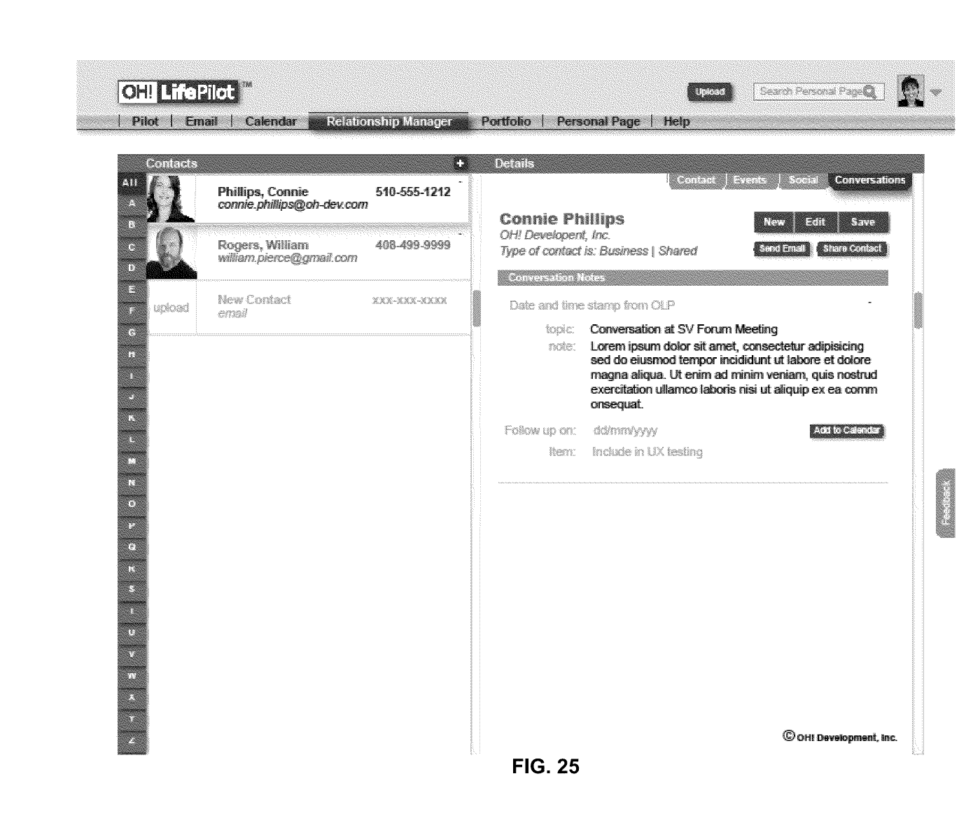

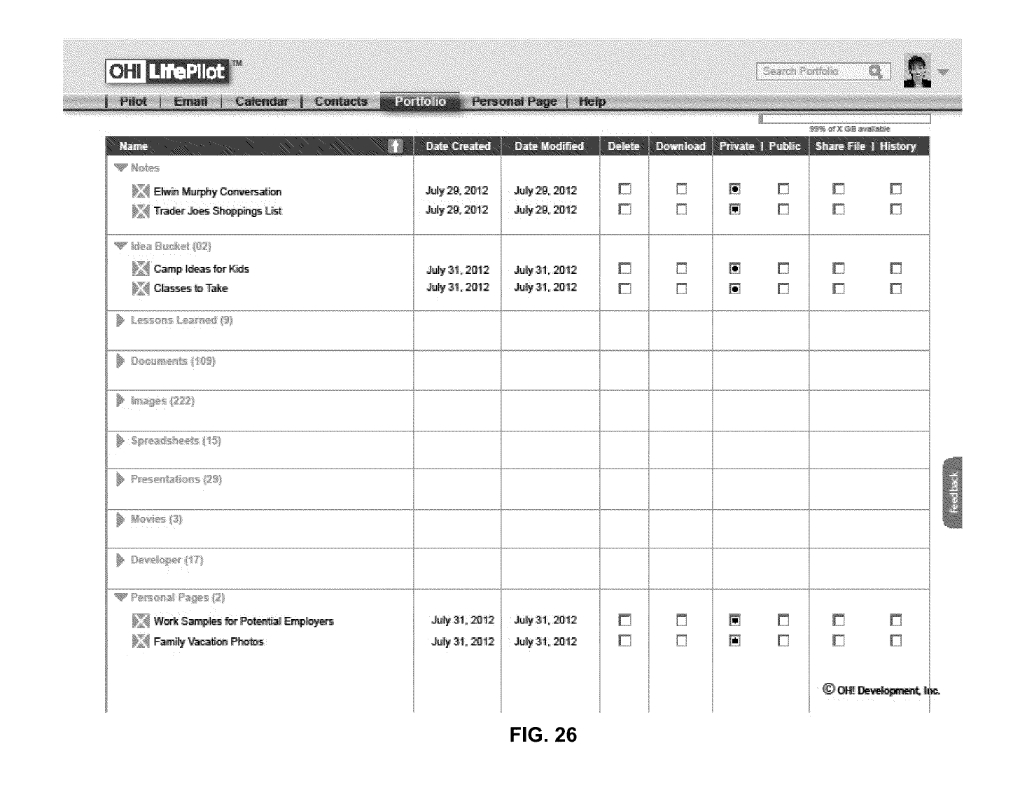

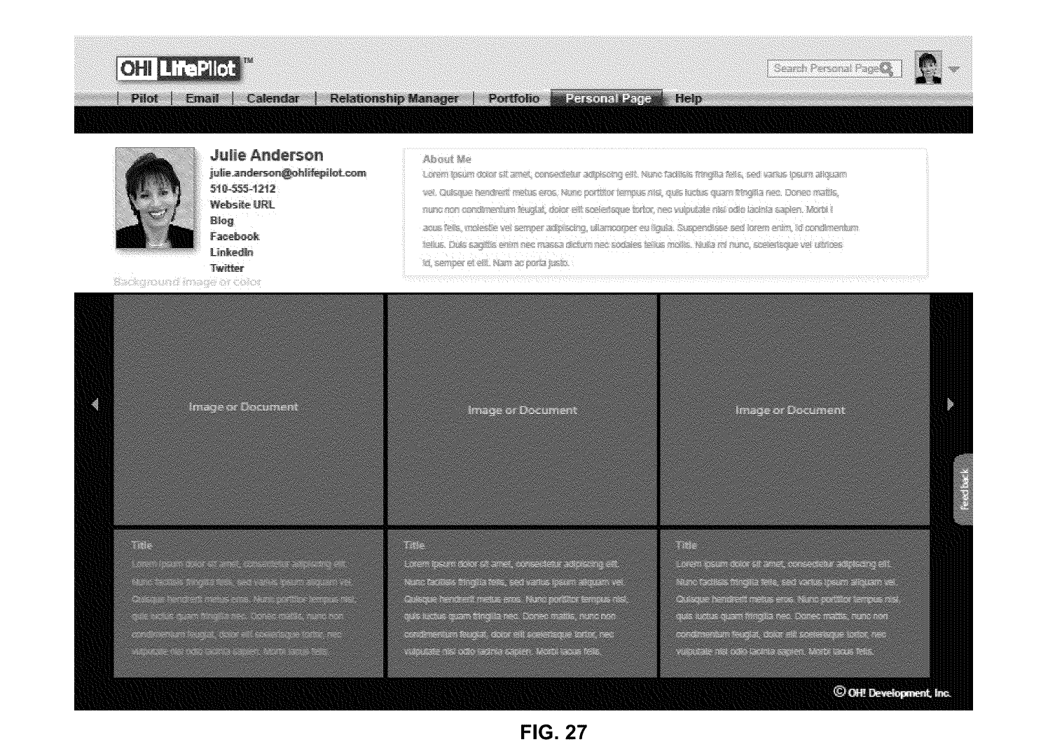

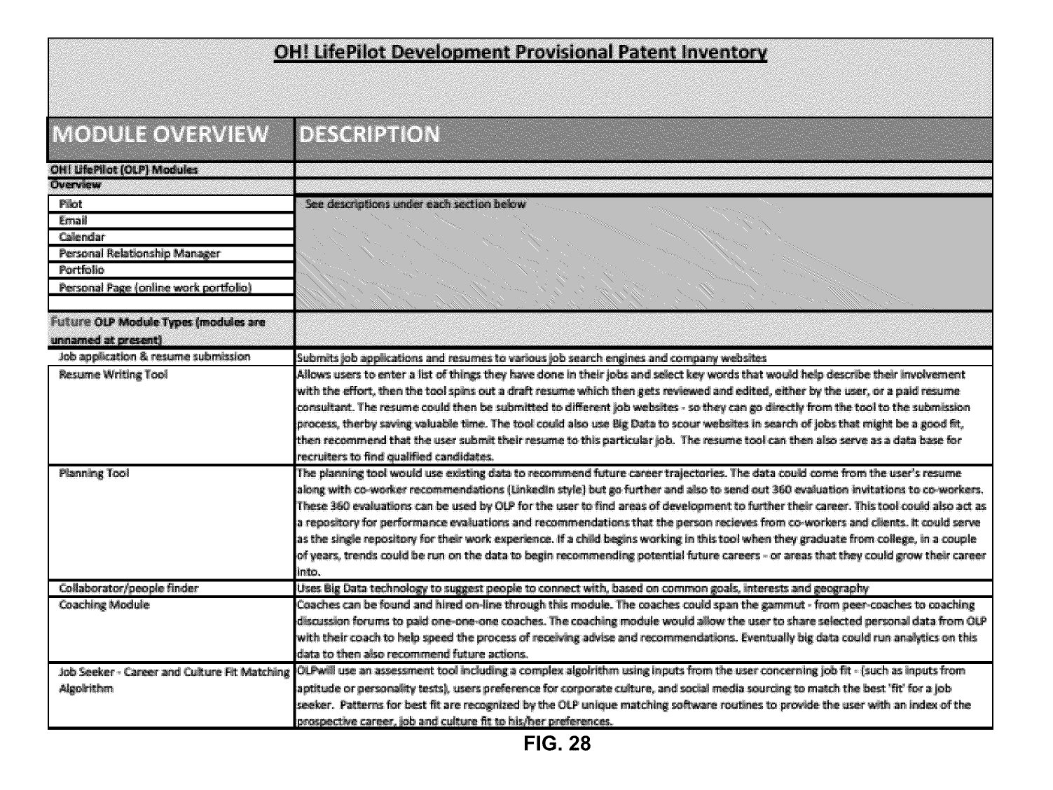

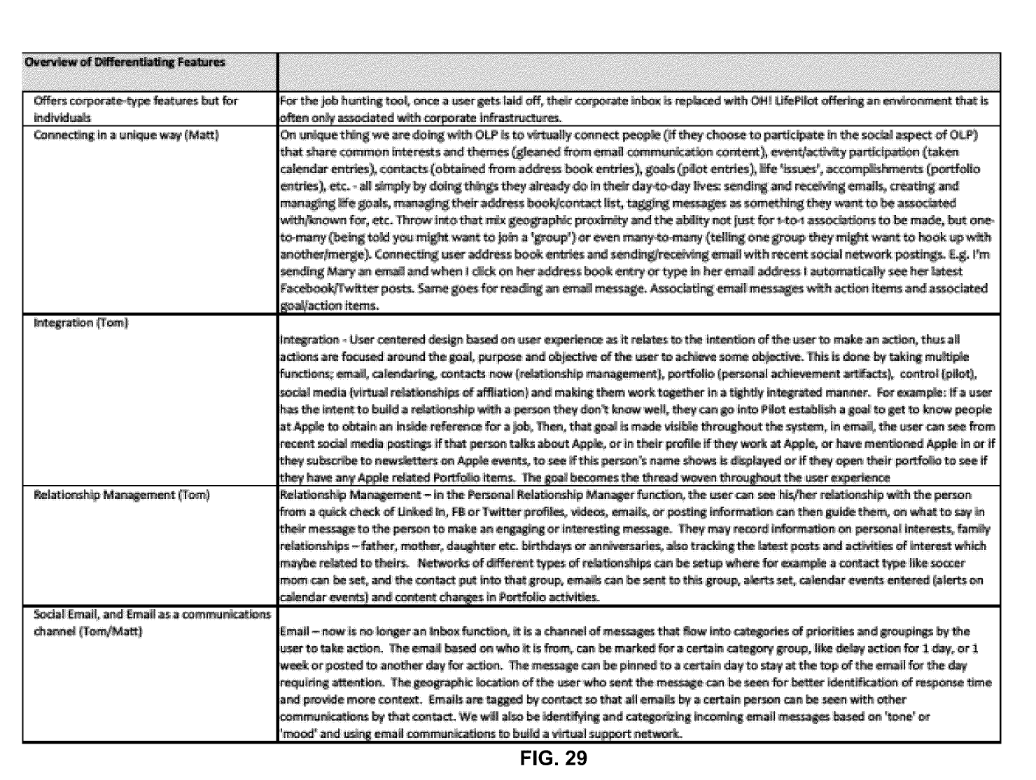

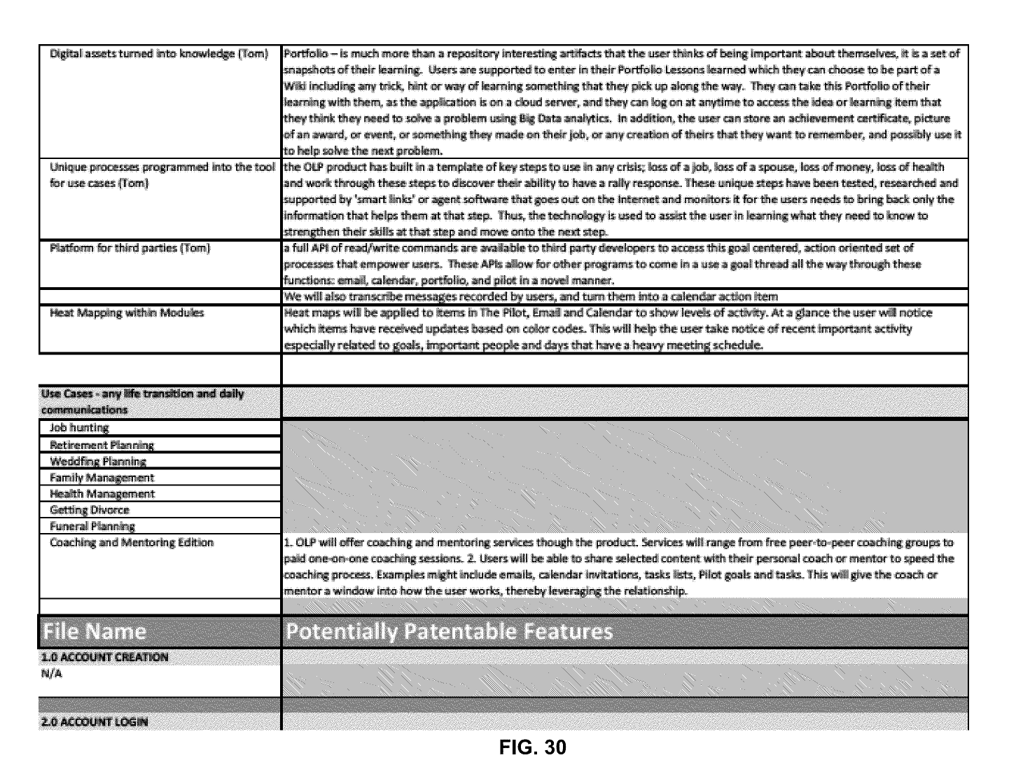

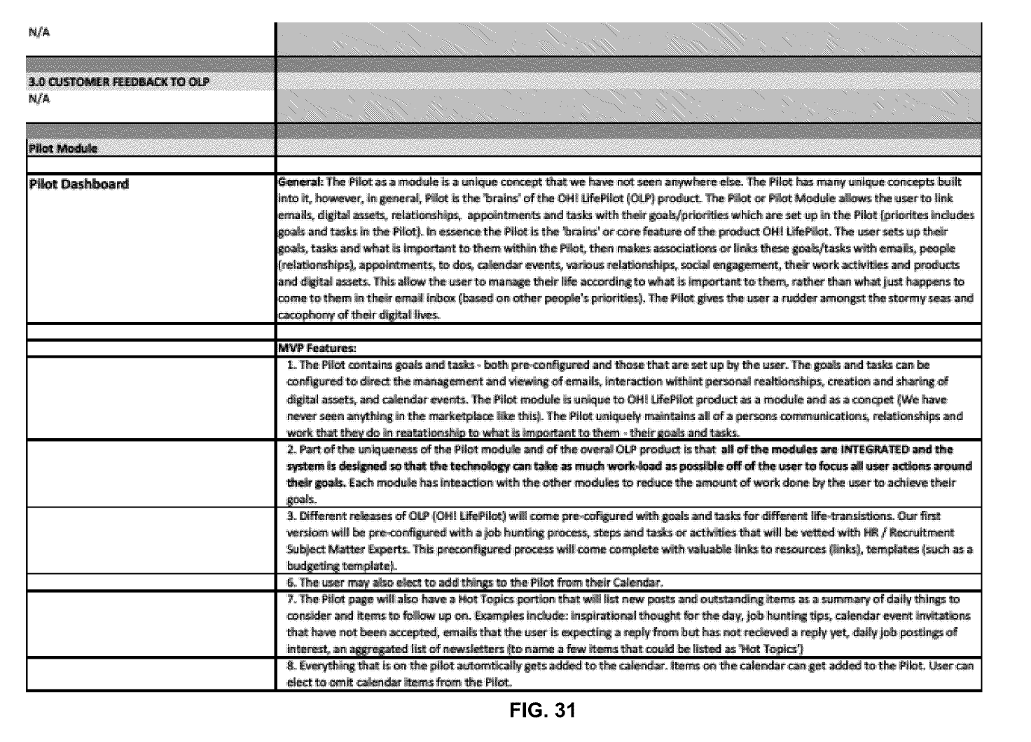

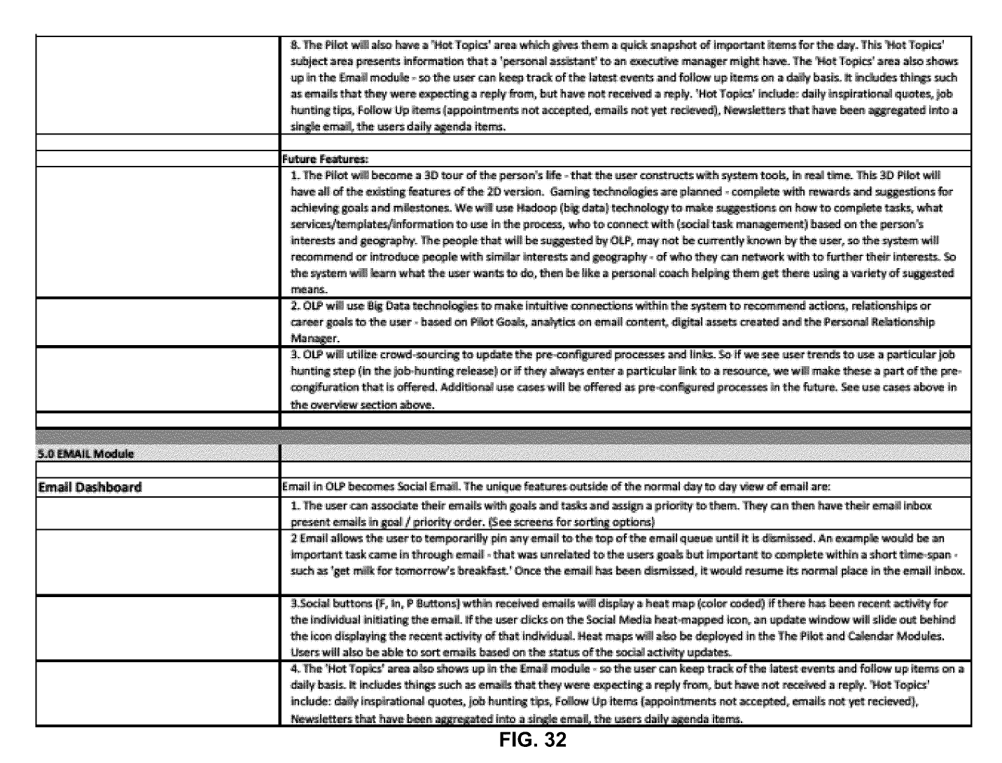

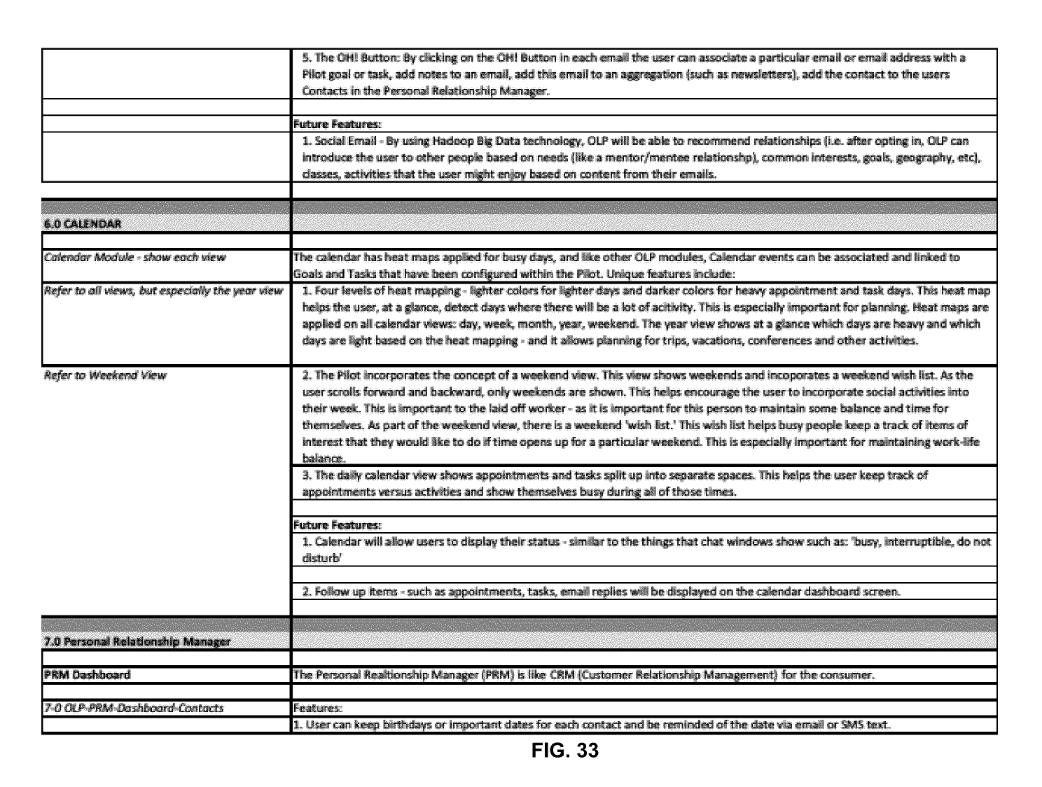

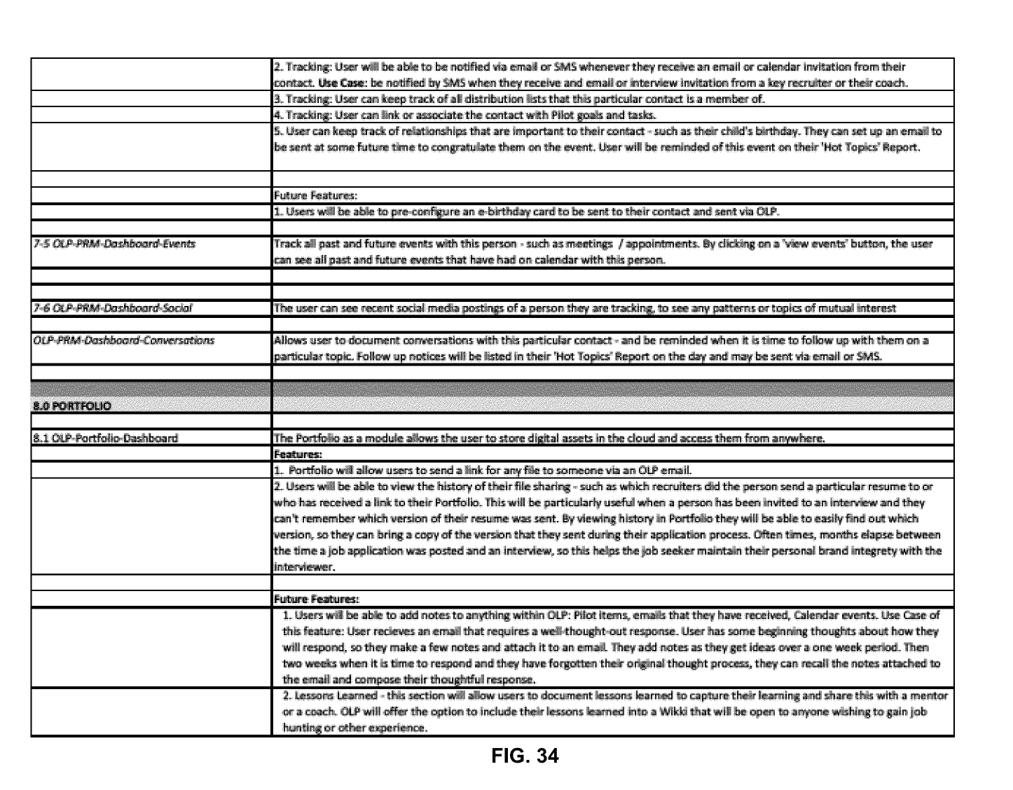

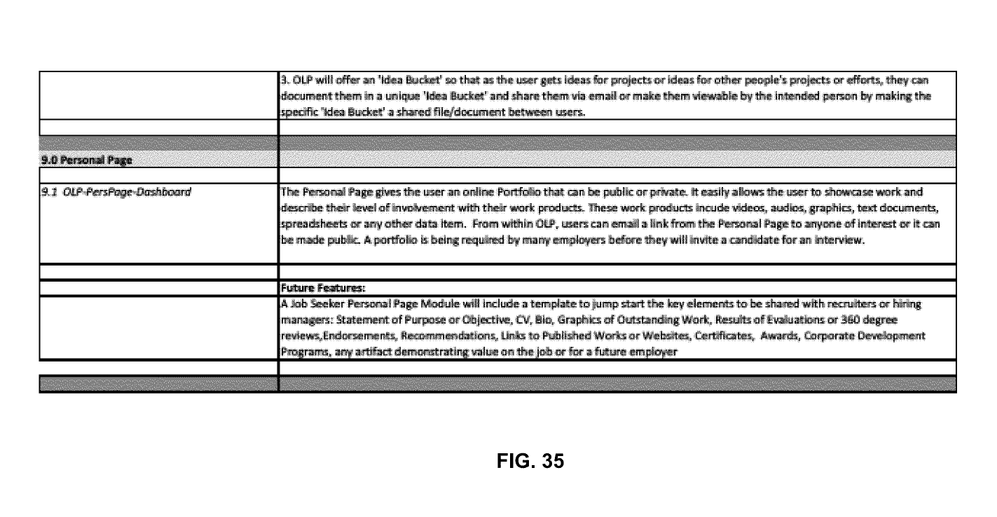

FIGS. 1-35 are example screenshots that illustrate various example views and features of a tool in accordance with various embodiments. The screenshots included herein illustrate at least one example embodiment of the tool. These screenshots are geared around, for example, a “job hunt” event. But it will be understood that the tool is a platform that can be used by a user to manage and deal with a variety of events, some of which are discussed above. Moreover, the tool can also be used separate and apart from event management as a platform for managing contacts—or more importantly relationships, emails, events, etc. In discussing the example of a job hunt, the broader capabilities of the tool will become apparent. Thus, the example provided herein should not be seen as limiting in terms of the range of possible embodiments and implementations.

Some implementations illustrated in the screenshots may include a pilot dashboard and module illustrated in the first screenshot. The pilot or a pilot module allows the user to link emails, digital assets, relationships, appointments and events and tasks with their goals/priorities which are set up in the pilot (priorities includes goals and tasks in the pilot). The user sets up their goals, tasks, resources and what is important to them within the pilot, then makes associations or links these goals/tasks with emails, people (relationships), appointments, to dos, calendar events, various relationships, social engagement, their work activities and products and digital assets. This allows the user to manage their life according to what is important to them, rather than what just happens to come to them in their email inbox (based on other people's priorities).

In other words, as illustrated in the first screenshot, once the user has defined a pilot process, in this case “job hunt”, for example, the user's calendar and communications can be filtered, prioritized, linked, and/or otherwise associated based on the process. Thus, their inbox is prioritized according to their goals and/or tasks (e.g., prioritizing their emails related to their goals and/or tasks). In some implementations, emails unrelated to their goals and/or tasks may be filtered and/or shown as low or lower priority items. The emails and messages related to the process are shown or prioritized in some manner so they stick out, are on top, etc. It is important to note that the user can define more than one process and that the tool can provide views and/or templates based on the event type; however, in most embodiments the templates are completely configurable and the user can define their own processes as well.

The other modules included in the tool and discussed below, then communicate with the pilot module in a two way communication process, i.e., as the pilot module defines a process, the pilot module can communicate with the other modules so that these modules know how to filter and display information and as information is entered or updated in one of these other modules, the module can communicate information that is relevant to a pilot process to the pilot module. Similarly, the other modules can communicate between each other and cooperate with each other in the filtering and display of data.

In certain embodiments, the pilot contains goals and tasks—both pre-configured and those that are set up by the user. The goals and tasks can be configured to direct the management and viewing of emails, interaction with personal relationships, creation and sharing of digital assets, work products and calendar events. The pilot uniquely maintains all of a person's communications, relationships and work that they do in relationship to what is important to them—their goals and tasks.

In some implementations, the pilot and/or other modules and components (e.g., email, calendar, relationship management, digital asset management, etc. up to the entire application) may use Big Data technologies to make intuitive connections within the system to recommend actions, relationships or career goals to the user—based on pilot goals, analytics on email content, calendar entries, digital assets created and a personal relationship manager. The term “Big Data” as used herein refers to a volume of both structured and unstructured data that it is difficult to process using traditional database and/or processing techniques.

The pilot will utilize crowd-sourcing to update the pre-configured processes and links. If the tool sees user trends to use a particular job-hunting step (in the job-hunting release) or if they always enter a particular link to a resource, the tool will make these a part of the pre-configuration that is offered. Additional use cases will be offered as pre-configured processes. See use cases above in the overview section above.

In addition, in certain embodiments, the pilot dashboard can be toggled between the calendar view illustrated in the first screenshot and the hot topics view illustrated in the second screenshot. This will allow users to see, at a glance, outstanding items and quick tips related to their processes in the pilot.

As noted, certain resources or tools can be linked to various steps in the process defined. For example, in the case of “job hunt” the following resources can be linked and made available through the tool: personal portfolio page, job application and resume submission tool, resume writing tool, planning tool, collaboration people finding tool, coaching tool, and a career and culture fit matching tool.

The job application and resume writing tool can be configured to submit job applications and resumes to various job search engines and company web sites.

The resume writing tool allows users to enter a list of things they have done in their jobs and select key words that would help describe their involvement with the effort, and then the tool spins out a draft resume which then gets reviewed and edited, either by the user, or a paid resume consultant. The resume could then be submitted to different job websites—so they can go directly from the tool to the submission process, thereby saving valuable time. The tool could also use Big Data to scour websites in search of jobs that might be a good fit, and then recommend that the user submit their resume to this particular job. The resume tool can then also serve as a data base for recruiters to find qualified candidates.

The planning tool can be configured to use existing data to recommend future career trajectories. The data could come from the user's resume, user's profile, career paths of peers, along with co-worker recommendations (LinkedIn style) but go further and also send out 360 evaluation invitations to gain insights from co-workers. These 360 evaluations can be used by the tool for the user to find areas of development or future career paths to further their career. This tool could also act as a repository for performance evaluations and recommendations that the person receives from co-workers, managers, peers, subject matter experts and clients. It could serve as the single repository for their work experience. If a child begins working in this tool early in their academic life and continue through when they graduate from college, trend analyses could be run on the data to begin recommending potential future careers - or areas that they could grow their career into. The tool could also assist the child in gaining comments and recommendations from teachers and eventually gaining admission into college and assist their counselors in making course and career recommendations for them.

The collaboration and people finder tool uses Big Data technology to suggest people to connect with, based on common goals, interests and geography.

The coaching tool can be configured to allow the user to find and hire coaches on-line through this module. The coaches could span the gamut—from peer-coaches to coaching discussion forums to paid one-one-one coaches. The coaching module would allow the user to share selected personal data from the tool with their coach to help speed the process of receiving advice and recommendations. Big data analytics can be run on this data to then also recommend future actions.

The job seeker tool will use an assessment tool including a complex algorithm using inputs from the user concerning job fit—(such as inputs from aptitude or personality tests), users preference for corporate culture, and social media sourcing to match the best ‘fit’ for a job seeker. Patterns for best fit are recognized by the tool's unique matching software routines to provide the user with an index of the prospective career; job and culture fit to his/her preferences.

The next set of screenshots illustrates the email module portion of the tool as seen through the dashboard email tab. The user can associate their emails with goals and tasks and assign a priority to them. They can then have their email inbox present emails in goal/priority order. (See screens for sorting options). The email tool allows the user to temporarily pin any email to the top of the email queue until it is dismissed. An example would be an important task came in through email—that was unrelated to the user's goals but important to complete within a short time-span—such as ‘get milk for tomorrow's breakfast.’ Once the email has been dismissed, it would resume its normal place in the email inbox.

The email module and/or other modules allow and support users making decisions while using an associated tool and/or user interface (e.g., making ad-hoc decisions, such as pinning an email somewhere until it is released—based on a one-time event that may not be part of the pilot process).

In certain embodiments, social buttons (e.g., buttons associated with social media or networks within received emails will display a heat map (color coded) if there has been recent activity for the individual initiating the email. If the user clicks on the social media heat-mapped icon, an update window will be shown in a module window. Heat maps will also be deployed in the pilot, calendar modules and other modules to indicate heavy activity. Users will also be able to sort emails based on the status of the social activity updates.

In certain embodiments, a mood indicator will display the tone or timber of the email. For instance if the email contains good news, the mood indicator will indicate this ‘tone’ through the use of analytics.

The ‘Hot Topics’ area may show up in the email module—so the user can keep track of the latest events and follow up items on a daily basis. It includes things such as emails that they were expecting a reply from, but have not received a reply. ‘Hot Topics’ include but are not limited to: daily inspirational quotes, job hunting tips, follow up items (appointments not accepted, emails not yet received), Newsletters that have been aggregated into a single email, the users daily agenda items and others. Other items that may show up in place of the ‘Hot Topics’ window include a carousel of email attachments within a given email. In some implementations, a user interface or window may provide combined functionality (e.g., the functionality of Hot Topics, attachment carousel, social updates, and others).

The OH! Button: By clicking on the OH! Button in each email the user can associate a particular email or email address with a pilot goal or task, add notes to an email, add this email to an aggregation (such as newsletters), add the contact to the users contacts in the personal relationship manager. In some implementations, a user may categorize and/or view contacts by associated goals (e.g., personal goals.)

In certain embodiments, by using Big Data technology, the tool will be able to recommend relationships (i.e. after opting in, the tool can introduce the user to other people based on needs (like a mentor/mentee relationship), common interests, goals, geography, etc.), classes, activities that the user might enjoy based on content from their emails, personal relationship manager or other items.

The next set of screenshots illustrates the calendar module portion of the tool as seen through the dashboard calendar tab. The calendar has heat maps applied for busy and light days, and like other modules, calendar events can be associated and linked to goals and tasks that have been configured within the pilot.

Multiple levels of heat mapping can be provided—lighter colors for lighter days and darker colors for heavy appointment and task days (e.g., heat mapping calendar dates based on the number of events and/or tasks scheduled on one or more calendars associated with a user). This heat map helps the user, at a glance, detect days where there will be a lot of activity (e.g., calendar entries may be categorized and displayed by events, tasks, and/or goals). This is especially important for planning. Heat maps are applied on all calendar views: day, week, month, year, and weekend. The year view shows at a glance which days are heavy and which days are light based on the heat mapping—and it allows planning for trips, vacations, conferences and other activities.

The calendar module incorporates the concept of a weekend view. This view shows weekends and incorporates a weekend wish list. As the user scrolls forward and backward, only weekends are shown in this view. This helps encourage the user to incorporate social activities into their week. This is important to the laid off worker—as it is important for this person to maintain some healthy balance and time for themselves. As part of the weekend view, there is a weekend ‘wish list.’ This wish list helps busy people keep a track of items of interest that they would like to do for planning purposes or if time opens up for a particular weekend. This is especially important for maintaining work-life balance. In some implementations, a user may associate and/or track calendar entries with personal goals.

The daily calendar view shows appointments and tasks split up into separate spaces. This helps the user keep track of appointments versus tasks or activities and shows that they are busy during all of those times.

The calendar module will allow users to display their status—similar to the things that chat windows show such as: ‘busy, interruptible, do not disturb, available’. The calendar tool can also be configured to allow follow up items—such as appointments, tasks, email replies will be displayed on the calendar dashboard screen.

The next set of screenshots illustrates the personal relationship manager tool as seen through the relationship manager tab of the pilot dashboard. The personal relationship manager (PRM) is like CRM (customer relationship management) for the individual user. This module can be used by the user to link contacts to goals and tasks and keep birthdays or important dates for each contact and be reminded of the date via email or short message service (SMS) text. An email can also be written ahead of time and scheduled for future delivery through the PRM. The user will also be able to be notified via email or SMS whenever they receive an email or calendar invitation from their contact. Use Case: be notified by SMS when they receive an email or interview invitation from a key recruiter or their coach. The user may also keep notes regarding general information about this contact—such as likes and dislikes, conversations with the contact or other important details.

The user can keep track of all distribution lists that this particular contact is a member of The user can also link or associate the contact with pilot goals and tasks or resources. The user can keep track of relationships that are important to their contact—such as their child's birthday, and they can set up an email to be sent at some future time to congratulate them particular events that they are tracking The user will be reminded of this event on their ‘Hot Topics’ Report.

Users will also be able to pre-configure an e-birthday card to be sent to their contact and sent via the tool. They can track all past and future events with this person—such as meetings/appointments. By clicking on a ‘view events’ button, the user can see all past and future events that they have had with this person. The user can see recent social media postings of a contact, to see any patterns or topics of mutual interest. The tool can also allow a user to document conversations with this particular contact—and be reminded when it is time to follow up with them on a particular topic or schedule a pre-written email for delivery at a future date. Follow up notices will be listed in their ‘Hot Topics’ Report or other reports on the day that the follow-up item is due and may be sent via email or SMS.

The next set of screenshots illustrates the portfolio tool as seen through the portfolio tab of the pilot dashboard. The portfolio as a module allows the user to store digital assets (e.g., in the cloud), access or share them from anywhere. For example, a user may upload files of any type to a file store and share one or more files (e.g., by reference or link) via an email message, a calendar entry, an event invitation, or other communication method. The portfolio will allow users to send a link for any file to someone via an email generated by the tool or make certain files public to be viewed by specific individuals or anyone within the OH! LifePilot tool.

Users will be able to view the history of their file sharing. One such example includes: which individuals or recruiters did the person send a particular document or resume to or who has received a link to their portfolio. This will be particularly useful when a person has been invited to an interview and they can't remember which version of their resume was sent. By viewing history in the portfolio they will be able to easily find out which version of a document they shared with this individual, so they can bring a copy of the version that they sent during their application process to interviews or other important meetings. Often times, months elapse between the time a job application was posted and an interview, so this helps the job seeker maintain their personal brand integrity with the interviewer.

Users will also be able to add notes to anything within the tool: pilot items, emails that they have sent or received, calendar events. Use Case of this feature: User receives an email that requires a well-thought-out response. User has some beginning thoughts about how they will respond, so they make a few notes and attach it to an email. They add notes as they get ideas over a one-week period. Then two weeks later, when it is time to respond and they have forgotten their original thought process, they can recall the notes attached to the email and compose their thoughtful response.

A Lessons Learned or wiki section will allow users to document lessons learned to capture their learning and share this with a mentor or a coach. The tool will offer the option for the user to contribute his or her lessons learned into a public Wikki that will be open to anyone wishing to gain current job hunting tips or other expertise. The portfolio tool can also offer an ‘Idea Bucket’ so that as the user gets ideas for their own projects or ideas for other people's projects or efforts, they can document them in a unique ‘Idea Bucket’ and share them via email or make them viewable by the intended person by making the specific ‘Idea Bucket’ a shared file/document between users.

The final screenshot illustrates the personal pages tool as seen through the personal page tab of the pilot dashboard. For example, one or more personal pages may be generated for a user to use and/or manage. A user may manage the content of a personal page by, for example, uploading files to the page and tagging the files as public, private, and/or other privacy levels. The personal page tool gives the user an online portfolio that can be shared based on the user's privacy settings (e.g., public or private). It easily allows the user to showcase work and describe their level of involvement with their work products. These work products include videos, audio files, graphics, text documents, spreadsheets or any other data item. From within the tool, users can email a link from the personal page to anyone of interest or the personal page can be made public.

A portfolio may be requested by many employers before they will invite a candidate for an interview. The personal page tool provides a mechanism that makes a user's work available through a simple, easy to use tool will help aid them in responding quickly to recruiters' needs and in getting a job or other work.

A job seeker personal page module can include a template to jump start the key elements to be shared with recruiters or hiring managers: Statement of Purpose or Objective, CV, Bio, Graphics of Outstanding Work, Results of Evaluations or 360 degree reviews, Endorsements, Recommendations, Links to Published Works or Websites, Certificates, Awards, Corporate Development Programs, any artifact demonstrating value on the job or for a future employer.

Thus, the tool provides a way to virtually connect people (if they choose to participate in the social aspect linked to or associated with the tool) that share common interests and/or themes (e.g., gleaned from email communication content), event/activity participation (e.g., taken from calendar entries), contacts (e.g., obtained from address book entries), goals (e.g., pilot entries), life ‘issues’, accomplishments (e.g., portfolio entries), etc. The tool connects people simply by doing things automatically what people do in their day-to-day lives, such as sending and receiving emails, creating and managing life goals, managing their address book/contact list, tagging messages as something they want to be associated with/known for, etc.

In some implementations, the tool can also take advantage of geographic proximity and therefore allow the ability not just for 1-to-1 associations to be made, but one-to-many (e.g., detecting or determining, based at least on the social aspects of a user, that the user might want to join a ‘group’) or even many-to-many (e.g., one or more users telling one group they might want to hook up with another/merge).

In some implementations, the tool may connect user address book entries, and sending/receiving email, with recent social network postings. For example, user A is sending user B an email and when user A clicks on user B's address book entry or user B's email address user A automatically sees user B's latest social posts. The same goes for reading an email message and/or other actions associated with pilot, email and/or address book entries. In some implementations, a user's email messages may be associated with action items and/or defined goals of the user.

In some implementations, the tool may allow a user to monitor the user's goals and task adherence (e.g., a user may opt into or turn on monitoring services provided by the tool). The monitoring services may provide motivation, products, resources or suggest relationships to accomplish the user's goals via, for example, reminders, input from other users, feedback, recommendations and/or associated content aggregated from social media and/or the Internet.

The tool also provides a user centered design based on user experience as it relates to the intention of the user to make an action, thus all actions are focused around the goal, purpose and objective of the user to achieve some objective. This is done by taking multiple functions; email, calendaring, contacts now (relationship management), portfolio (personal achievement artifacts), control (pilot), social media (virtual relationships of affiliation) and making them work together in a tightly integrated manner. For example: If a user has the intent to build a relationship with a person they don't know well, they can go into pilot establish a goal to get to know people at XYZ Company to obtain an inside reference for a job, then, that goal is made visible throughout the system, in email, the user can see from recent social media postings if that person talks about XYZ Company, or in their profile if they work at XYZ Company, or have mentioned the company in or if they subscribe to newsletters on the company's events, to see if this person's name is displayed or if they open their portfolio to see if they have any XYZ Company related portfolio items. The goal becomes the thread woven throughout the user experience.

In the personal relationship manager function, the user can see his/her relationship with the person from a quick check of LinkedIn®, Facebook®, Twitter® or other social profiles, videos, emails, or posting information which can then provide information that can guide them, on what to say in their message to the person to make an engaging or interesting message. They may record information on personal interests, family relationships—father, mother, daughter etc. birthdays or anniversaries, also tracking the latest posts and activities of interest which may be related to theirs. Networks of different types of relationships can be setup where for example a contact type like soccer mom can be set, and the contact put into that group, emails can be sent to this group, alerts set, calendar events entered (alerts on calendar events) and content changes in Portfolio activities.

The tool also makes it such that email is no longer just an Inbox function; it is a channel of messages that flow into categories of priorities and groupings by the user to take action. The email based on who it is from, can be marked for a certain category group or goal, and delayed for a period time such as 1 day, or 1 week or posted to another day for action. The email message requiring attention can be pinned to stay at the top of the email inbox until it is released. The geographic area of the user who sent the message can be seen for better identification of response time and provide more context. Emails are tagged by contact so that all emails by a certain person can be seen with other communications by that contact. Emails may also be identified and categorized based on ‘tone’ or ‘mood’ (e.g., detecting good news or bad news from the content of an email) of the email and using email communications to build a virtual support network.”

In addition, the portfolio—is much more than a repository of interesting artifacts, it is a set of snapshots of their learning. Users are supported to enter in their portfolio lessons learned which they can choose to be part of a Wiki including any trick, hint or way of learning something that they pick up along the way. They can take this portfolio of their learning with them, as the application is on a cloud server, and they can log on at any time to access the idea or learning item that they think they need to solve a problem using Big Data analytics. In addition, the user can store an achievement certificate, picture of an award, or event, or something they made on their job, or any creation of theirs that they want to remember, and possibly use it to help solve the next problem.

The tool also can have built into it, a template of key steps to use in a crisis; loss of a job, loss of a spouse, loss of money, loss of health. They can then work through these steps to discover their ability to resolve the crises or have a ‘rally response.’ These unique key steps have been researched and are supported by ‘smart links’ or agent software that goes out on the Internet and monitors topics for the user's needs to bring back only the information that helps them at that step. Thus, the technology is used to assist the user in learning what they need to know to solve problems and strengthen their skills at that step and move onto the next step. Big data can also be used to suggest products or services to the user based on what they are looking for or want.

The tool also provides a full API of read/write commands which are available to third party developers to access the goal centered, action oriented set of processes that empower users. These APIs can allow for other programs to come in and use a goal-thread all the way through these functions: email, calendar, portfolio, and pilot in a novel manner.

The tool can also receive voice recordings of the users, transcribe messages recorded by users, and turn them into calendar action items, idea bucket items, goals, tasks or other items.

Heat maps can be applied to items in the pilot, email and calendar to show levels of activity. At a glance the user will notice which items have received updates based on color codes. This will help the user take notice of recent important activity especially related to goals, important people and days that have a heavy meeting schedule.

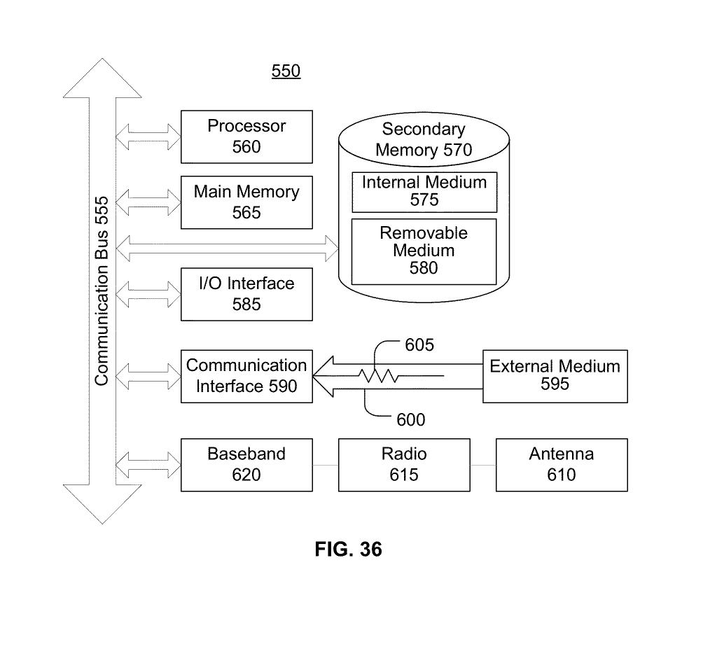

FIG. 36 is a block diagram illustrating an example wired or wireless system 550 that may be used in connection with various embodiments described herein. For example the system 550 may be used as or in conjunction with one or more of the mechanisms or processes described above, and may represent components of server(s) 110, user system(s) 130, and/or other devices described herein. The system 550 can be a server or any conventional personal computer, or any other processor-enabled device that is capable of wired or wireless data communication. Other computer systems and/or architectures may be also used, as will be clear to those skilled in the art.

The system 550 preferably includes one or more processors, such as processor 560. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 560. Examples of processors which may be used with system 550 include, without limitation, the Pentium® processor, Core i7® processor, and Xeon® processor, all of which are available from Intel Corporation of Santa Clara, California.

The processor 560 is preferably connected to a communication bus 555. The communication bus 555 may include a data channel for facilitating information transfer between storage and other peripheral components of the system 550. The communication bus 555 further may provide a set of signals used for communication with the processor 560, including a data bus, address bus, and control bus (not shown). The communication bus 555 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, or standards promulgated by the Institute of Electrical and Electronics Engineers (IEEE) including IEEE 488 general-purpose interface bus (GPIB), IEEE 696/S-100, and the like.

System 550 preferably includes a main memory 565 and may also include a secondary memory 570. The main memory 565 provides storage of instructions and data for programs executing on the processor 560, such as one or more of the functions and/or modules discussed above. It should be understood that programs stored in the memory and executed by processor 560 may be written and/or compiled according to any suitable language, including without limitation C/C++, Java, JavaScript, Pearl, Visual Basic, .NET, and the like. The main memory 565 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

The secondary memory 570 may optionally include an internal memory 575 and/or a removable medium 580, for example a floppy disk drive, a magnetic tape drive, a compact disc (CD) drive, a digital versatile disc (DVD) drive, other optical drive, a flash memory drive, etc. The removable medium 580 is read from and/or written to in a well-known manner. Removable storage medium 580 may be, for example, a floppy disk, magnetic tape, CD, DVD, SD card, etc.

The removable storage medium 580 is a non-transitory computer-readable medium having stored thereon computer executable code (i.e., software) and/or data. The computer software or data stored on the removable storage medium 580 is read into the system 550 for execution by the processor 560.

In alternative embodiments, secondary memory 570 may include other similar means for allowing computer programs or other data or instructions to be loaded into the system 550. Such means may include, for example, an external storage medium 595 and an interface 590. Examples of external storage medium 595 may include an external hard disk drive or an external optical drive, or and external magneto-optical drive.

Other examples of secondary memory 570 may include semiconductor-based memory such as programmable read-only memory (PROM), erasable programmable read-only memory (EPROM), electrically erasable read-only memory (EEPROM), or flash memory (block oriented memory similar to EEPROM). Also included are any other removable storage media 580 and communication interface 590, which allow software and data to be transferred from an external medium 595 to the system 550.

System 550 may include a communication interface 590. The communication interface 590 allows software and data to be transferred between system 550 and external devices (e.g. printers), networks, or information sources. For example, computer software or executable code may be transferred to system 550 from a network server via communication interface 590. Examples of communication interface 590 include a built-in network adapter, network interface card (NIC), Personal Computer Memory Card International Association (PCMCIA) network card, card bus network adapter, wireless network adapter, Universal Serial Bus (USB) network adapter, modem, a network interface card (NIC), a wireless data card, a communications port, an infrared interface, an IEEE 1394 fire-wire, or any other device capable of interfacing system 550 with a network or another computing device.

Communication interface 590 preferably implements industry promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 590 are generally in the form of electrical communication signals 605. These signals 605 are preferably provided to communication interface 590 via a communication channel 600. In one embodiment, the communication channel 600 may be a wired or wireless network, or any variety of other communication links. Communication channel 600 carries signals 605 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 565 and/or the secondary memory 570. Computer programs can also be received via communication interface 590 and stored in the main memory 565 and/or the secondary memory 570. Such computer programs, when executed, enable the system 550 to perform the various functions of the present invention as previously described.

In this description, the term “computer readable medium” is used to refer to any non-transitory computer readable storage media used to provide computer executable code (e.g., software and computer programs) to the system 550. Examples of these media include main memory 565, secondary memory 570 (including internal memory 575, removable medium 580, and external storage medium 595), and any peripheral device communicatively coupled with communication interface 590 (including a network information server or other network device).

These non-transitory computer readable mediums are means for providing executable code, programming instructions, and software to the system 550.

In an embodiment that is implemented using software, the software may be stored on a computer readable medium and loaded into the system 550 by way of removable medium 580, I/O interface 585, or communication interface 590. In such an embodiment, the software is loaded into the system 550 in the form of electrical communication signals 605. The software, when executed by the processor 560, preferably causes the processor 560 to perform the inventive features and functions previously described herein.

In an embodiment, I/O interface 585 provides an interface between one or more components of system 550 and one or more input and/or output devices. Example input devices include, without limitation, keyboards, touch screens or other touch-sensitive devices, biometric sensing devices, computer mice, trackballs, pen-based pointing devices, and the like. Examples of output devices include, without limitation, cathode ray tubes (CRTs), plasma displays, light-emitting diode (LED) displays, liquid crystal displays (LCDs), printers, vacuum florescent displays (VFDs), surface-conduction electron-emitter displays (SEDs), field emission displays (FEDs), and the like.

The system 550 also includes optional wireless communication components that facilitate wireless communication over a voice and over a data network. The wireless communication components comprise an antenna system 610, a radio system 615 and a baseband system 620. In the system 550, radio frequency (RF) signals are transmitted and received over the air by the antenna system 610 under the management of the radio system 615.

In one embodiment, the antenna system 610 may comprise one or more antennae and one or more multiplexors (not shown) that perform a switching function to provide the antenna system 610 with transmit and receive signal paths. In the receive path, received RF signals can be coupled from a multiplexor to a low noise amplifier (not shown) that amplifies the received RF signal and sends the amplified signal to the radio system 615.

In alternative embodiments, the radio system 615 may comprise one or more radios that are configured to communicate over various frequencies. In one embodiment, the radio system 615 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from the radio system 615 to the baseband system 620.

If the received signal contains audio information, then baseband system 620 decodes the signal and converts it to an analog signal. Then the signal is amplified and sent to a speaker. The baseband system 620 also receives analog audio signals from a microphone. These analog audio signals are converted to digital signals and encoded by the baseband system 620. The baseband system 620 also codes the digital signals for transmission and generates a baseband transmit audio signal that is routed to the modulator portion of the radio system 615. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 610 where the signal is switched to the antenna port for transmission.

The baseband system 620 is also communicatively coupled with the processor 560. The central processing unit 560 has access to data storage areas 565 and 570. The central processing unit 560 is preferably configured to execute instructions (i.e., computer programs or software) that can be stored in the memory 565 or the secondary memory 570. Computer programs can also be received from the baseband processor 610 and stored in the data storage area 565 or in secondary memory 570, or executed upon receipt. Such computer programs, when executed, enable the system 550 to perform the various functions of the present invention as previously described. For example, data storage areas 565 may include various software modules (not shown).

Various embodiments may also be implemented primarily in hardware using, for example, components such as application specific integrated circuits (ASICs), or field programmable gate arrays (FPGAs). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, functions, and methods described in connection with the embodiments disclosed herein can be implemented or performed with a general purpose processor, a digital signal processor (DSP), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

Any of the software components described herein may take a variety of forms. For example, a component may be a stand-alone software package, or it may be a software package incorporated as a “tool” in a larger software product. It may be downloadable from a network, for example, a website, as a stand-alone product or as an add-in package for installation in an existing software application. It may also be available as a client-server software application, as a web-enabled software application, and/or as a mobile application.

While certain embodiments have been described above, it will be understood that the embodiments described are by way of example only. Accordingly, the systems and methods described herein should not be limited based on the described embodiments. Rather, the systems and methods described herein should only be limited in light of the claims that follow when taken in conjunction with the above description and accompanying drawings.

What is claimed:

1. A system comprising:
a pilot module configured to:
generate a personal process based on preconfigured items and/or input from a user of a type of event related to the process, and
link and integrate contacts, emails and other forms of communications, digital assets, events, and resources with the milestones, goals and timing within the generated process, and
display messages, events, actions, relationships, digital assets and other linked items in a manner prioritized based on the process and links therewith; and
a plurality of other modules configured to work in conjunction with the pilot module to allow the user to manage the generated process;

2. The system of claim 1, wherein the pilot module is further configured to track and manage personal relationships, emails and other forms of communication, digital assets, events and actions according to their relationship with the pilot processes

3. The system of claim 1, wherein the personal process consists of milestones, goals, tasks and timelines and links to important web or private content.

4. The system of claim 1, wherein the pilot module is further configured to color code items displayed by the pilot module.

5. The system of claim 1, wherein the pilot module is further configured to color code the items based on at least one of recent activity, importance of a message, and importance of an event. The system of claim 1, wherein one of the plurality of other modules is an email module.

6. The system of claim 1, wherein one of the plurality of other modules is a personal relationship module.

7. A system comprising:
a plurality of module, including a pilot module configured to generate a personal process based on preconfigured items and/or input from a user of a type of event related to the process;
a plurality of other modules configured to work in conjunction with the pilot module to allow the user to manage the generated process; and
a dashboard user interface configured to display information related to each module and apply a filter across the modules so as to filter information for display within the modules based on the generated process.

8. The system of claim 7, wherein the pilot module is further configured to:
link and integrate contacts, emails and other forms of communications, digital assets, events, and resources with the milestones, goals and timing within the generated process; and
display messages, events, actions, relationships, digital assets and other linked items within the dashboard in a manner prioritized based on the process and links therewith.

9. The system of claim 7, wherein the pilot module is further configured to track and manage personal relationships, emails and other forms of communication, digital assets, events and actions according to their relationship with the pilot processes

10. The system of claim 7, wherein the personal process consists of milestones, goals, tasks and timelines and links to important web or private content.

11. The system of claim 7, wherein the pilot module is further configured to color code items displayed by the pilot module.

12. The system of claim 7, wherein the pilot module is further configured to color code the items based on at least one of recent activity, importance of a message, and importance of an event. The system of claim 1, wherein one of the plurality of other modules is an email module.

13. The system of claim 7, wherein one of the plurality of other modules is a personal relationship module.

14. A system comprising:
a pilot module configured to generate a personal process based on preconfigured items and/or input from a user of a type of event related to the process; and
an email module configured to work in conjunction with the pilot module to allow the user to manage emails based on the generated process, the email module configured to perform at least one of the following functions:
sort emails based on the generated process,
color code emails based on the generated process,
display emails based on the generated process,
keep emails on top based on the generated process, and
keep emails on top based on ad hoc decisions made by the user.

15. The system of claim 14, further comprising a plurality of other modules configured to work in conjunction with the pilot module to allow the user to manage the generated process.

16. The system of claim 14, further comprising a dashboard user interface configured to display information related to each module and to link modules to the pilot and apply a filter across the modules so as to filter information for display within the modules based on the generated process.

17. The system of claim 14, wherein the pilot module is further configured to:
link and integrate contacts, emails and other forms of communications, digital assets, events, and resources with the milestones, goals and timing within the generated process, and
display messages, events, actions, relationships, digital assets and other linked items within the dashboard in a manner prioritized based on the process and links therewith.

18. The system of claim 14, wherein the pilot module is further configured to track and manage personal relationships, emails and other forms of communication, digital assets, events and actions according to their relationship with the pilot processes.

19. The system of claim 14, wherein the personal process consists of milestones, goals, tasks and timelines and links to important web or private content.

20. The system of claim 14, wherein the pilot module is further configured to color code items displayed by the pilot module.
